(19) United States
(12) Patent Application Publication
(10) Pub. No.: US 2026/0266865 A1
(43) Pub. Date: Sep. 10, 2026

(54) A DISPENSING SYSTEM, A METHOD OF PURGING A DISPENSER AND A PURGE INITIATION SYTEM

(71) Applicant: 3M INNOVATIVE PROPERTIES COMPANY, St. Paul, MN (US)

(72) Inventors: John A. Merchant, Apple Valley, MN (US); Aline Serrao De Filippo, Falcon Heights, MN (US); Won Joon Choi, St. Paul, MN (US)

(21) Appl. No.: 19/491,416

(22) PCT Filed: Jun. 10, 2024
(86) PCT No.: PCT/IB2024/055664

§ 371 Date: Dec. 9, 2025

Related U.S. Application Data
(60) Provisional application No. 63/507,672, filed on Jun. 12, 2023.

(51) Int. Cl. G01P 13/00; B05B 12/00; B05B 15/50

(52) U.S. Cl. CPC G01P 13/0053; B05B 12/008; B05B 15/50

(57) ABSTRACT

A dispensing system is presented that includes a channel through which a material to be dispensed flows. The system includes a sensor within the channel, in direct contact with the material. The sensor is configured to generate a sensor signal indicative of an electrical parameter of the material flow. The system also includes a flow state detector configured to, based on the sensed electrical parameter, detect a change in flow state of the material within the channel. The change in flow state comprises a start of flow or a stop of flow. The system also includes a communication component configured to communicate the detected change in flow state.

### BACKGROUND

Systems for dispensing adhesives typically include an inlet or internal area for holding the adhesive, and an output or tip through which adhesive is dispensed to a surface. The flow rate of the adhesive can be directly controlled to meet needs of downstream manufacturing processes by using metering systems. Many systems dispense multiple components that mix together in a mixing chamber. There is a general need to more accurately measure mixing quality and other dispensing parameters in a timely and cost-effective manner.

### SUMMARY OF THE DISCLOSURE

A dispensing system is presented that includes a channel through which a material to be dispensed flows. The system includes a sensor within the channel, in direct contact with the material. The sensor is configured to generate a sensor signal indicative of an electrical parameter of the material flow. The system also includes a flow state detector configured to, based on the sensed electrical parameter, detect a change in flow state of the material within the channel. The change in flow state comprises a start of flow or a stop of flow. The system also includes a communication component configured to communicate the detected change in flow state.

Systems and methods herein also allow for multiple sensor signals to be gathered across a fluid flow, providing real-time information about materials going into, and out of, a mixing area. Systems and methods herein also detect starts and stops of fluid flow in a dispenser, allowing for accurate purging of material to prevent clogs or curing within the dispenser.

The above summary of the present disclosure is not intended to describe each disclosed embodiment or every implementation of the present disclosure. The description that follows more particularly exemplifies illustrative embodiments. In several places throughout the application, guidance is provided through lists of examples, which examples may be used in various combinations. In each instance, the recited list serves only as a representative group and should not be interpreted as an exclusive list. Thus, the scope of the present disclosure should not be limited to the specific illustrative structures described herein, but rather extends at least to the structures described by the language of the claims, and the equivalents of those structures. Any of the elements that are positively recited in this specification as alternatives may be explicitly included in the claims or excluded from the claims, in any combination as desired. Although various theories and possible mechanisms may have been discussed herein, in no event should such discussions serve to limit the claimable subject matter.

### BRIEF DESCRIPTION OF FIGURES

FIG. 1 illustrates an adhesive dispenser in which example embodiments can be implemented.

FIGS. 2A-2B illustrate a single PCB material measurement flow sensor in accordance with embodiments herein.

FIG. 3A-3B illustrates a material characterization system in which example embodiments can be implemented.

FIG. 4 illustrates a method for controlling a material dispensing system in which embodiments herein may be useful.

FIG. 5 illustrates a method for automatically purging a dispensing system in accordance with embodiments herein.

FIGS. 6A-6D illustrate conductivity tracking examples in accordance with embodiments herein.

FIGS. 7A-7B illustrate example user interfaces generated by a dispenser control system in accordance with embodiments herein.

FIGS. 8A-8B illustrate conductivity measurements over time in accordance with embodiments herein.

FIG. 9 illustrates a method for automatically triggering a purge in accordance with embodiments herein.

FIGS. 10A-10F illustrate a purge time calculation in accordance with embodiments herein.

FIG. 11 illustrates a material dispensing system in accordance with embodiments herein.

FIGS. 12A-B illustrates a conductivity measurement system in an example network architecture.

FIGS. 13A-13D illustrate a sensor signal receiving system in accordance with embodiments herein.

FIG. 14 illustrates a dispensing system in accordance with embodiments herein.

FIGS. 15-17 illustrate example computing devices that can be used in embodiments herein.

FIGS. 18-23 illustrate results obtained from Examples described herein.

### DETAILED DESCRIPTION OF ILLUSTRATIVE EMBODIMENTS

The present disclosure relates to sensors that can determine properties of fluids and to methods for determining properties of fluids. The disclosure also relates to data sets received by such sensors and methods of using said data for improving operation of dispensing operations. Many industrial processes use liquid materials such as liquid adhesives, liquid food ingredients, liquid coolants, or liquid reaction products, to name a few examples. Certain properties of such liquids vary over time: adhesives may cure, an oil may become less viscous as temperature rises, a coolant may age and have a lower heat capacity than initially.

Many industrial processes, however, rely on certain properties of a liquid being within a specified range or being unchanged compared to the property in an initial state. For example, adhesives, or adhesive mixtures, may have different curing properties when applied at different temperatures, different mixing ratios, etc.

Co-pending international application PCT/US2022/052343, filed on Dec. 9, 2022, discloses a single-use sensor capable of measuring conductivity, impedance and/or dielectric constant by direct contact with a fluid.

Described herein are sensors and sensor systems that are used to measure electrical properties of fluids and, based on said properties, detect a status of a fluid in a dispenser. Broadly sensors herein function by a transmitting electrode receiving a voltage, which creates an electrical field. As a fluid flows between the transmitting electrode and a receiving electrode, it conducts a current to the receiving electrode. It is expressly contemplated that, in some embodiments, a transmitting electrode may receive a current, and a receiving electrode may sense a voltage.” The term “sensor” as used herein may refer both to the physical sensor that provides a sensor signal indicative of conducted current, as well as to a “sensor system” that includes a processor that calculates an electrical property of the fluid based on the sensor signal.

Electrical parameters, as used herein, may be detected by an electrode pair. Fluid may flow between or past the electrode pair. A transmitting electrode may generate an electric field when a voltage or a current is applied, while a receiving electrode receives a current or voltage. The sensed electrical parameter may be a conductivity, relative permittivity or an impedance. The terms relative permittivity and dielectric constant are used herein interchangeably.

The term “electrical property” is intended to broadly refer to any electrical property of a fluid that can be derived based on impedance measurements of a sensor. Used herein, for ease of understanding the embodiments, are the example of impedance measurements. However, it is expressly contemplated that other electrical properties may be calculated and relevant to embodiments herein. For example, conductivity measurements or dielectric constants may also be determined from impedance measurements. Either conductivity or dielectric constant may be relevant, as illustrated herein, for determining relevant functionality of a dispensing system or quality of fluids flowing therein.

As described herein, sensors are described as measuring electrical properties of “fluids.” The term “fluid” is intended to be interpreted broadly and is intended to cover liquids with low viscosities, liquids with high viscosities, semi-solid materials, suspensions, melted materials, or other flowable materials.

The term “curing” as used herein is intended to broadly cover a changing of a material from a first state to a second state. For example, some liquids cure into solids. Some mixtures may experience crosslinking. Some mixtures may experience pre-polymerization. Some mixtures may experience conversion. Detecting these and other similar state changes are expressly contemplated for embodiments herein.

As used herein, the term “real-time” refers to data is processed within milliseconds so that it is available virtually immediately as feedback. While some delay due to processing are inevitable, “real-time” is intended to cover systems and methods where data can be collected or entered and a user can then interact with it without noticeable delay. E.g. a user may make a data entry into a system, and the data entry is then substantially immediately available for viewing or editing.

Sensors are described herein as having one or more “apertures” within a “printed circuit board.” These terms are intended to be interpreted broadly. For example, an aperture may fully extend through a thickness of a sensor along part of, or the entirety of its length. Apertures may have beveling along part or all of a perimeter. An aperture may be elongated, such as a slot, or may be shaped, such as a circular or ovular hole. An aperture may have one or more corners or edges, or may have curvature along part or all of its perimeter. As used herein, a “printed circuit board” refers to a laminated sandwich structure of conductive and insulating layers. Printed circuit boards (PCBs) herein may include any number of terminals and conductors that allow for voltage to be applied to a transmitting electrode and for current to be transmitted from a receiving electrode. In some embodiments, however, a current may be provided to transmitting electrode and a voltage received at the receiving electrode. PCBs may be manufactured using traditional PCB manufacturing technology or additive manufacturing technology. As used herein, PCB is intended to cover any number of layers, with or without an edge connector. Any suitable conductive metal may be used to form conductive layers. Any suitable insulating material may be used to form insulating layers. While an edge connector is illustrated, it is expressly contemplated that other suitable options may be used to transmit a signal from a receiving electrode for analysis. For example, a wired or wireless connection—for example an RFID chip or an NFC chip.

Any suitable technique may be used to form sensors of the present disclosure, including those known to one skilled in the art having the benefit of the present disclosure. In some embodiments, the sensors may be formed using 3D electronics printing techniques, such as electronics printing on 3D substrates or fully additive manufacturing. Non-limiting examples of fully additive manufacturing include fused filament fabrication, stereolithography, or inkjet printing. In the fully additive manufacturing approach, both electronic and structural elements of the sensor may be made using one or more additive manufacturing techniques and this approach may also be described as a fully integrated manufacturing approach. In general, the structural elements of the sensor may be described as substrate material, and the electronics elements of the sensor may be described as functional material.

Suitable substrate materials usable in 3D electronics printing techniques may include polymers or ceramics. Substrates may include flexible materials, such as polyimide or polyethylene terephthalate (PET). The substrate material may be selected to have good adhesion properties to the functional materials used, to withstand curing or sintering used in the printing process, and to be sufficiently durable for the intended application of the sensor. The substrate materials may be used to form structural elements of the sensor (e.g., dielectric substrate of the printed circuit board) using any suitable technique, including additive manufacturing techniques.

Suitable functional materials usable in 3D electronics printing techniques may include conductive inks, dielectric inks, hybrid inks, or other functional inks. In some embodiments, conductive inks may be used to print conductive traces, electrodes, and interconnects. Conductive inks generally include conductive materials, such as silver nanoparticles, graphene, or nanotubes, dispersed in a liquid medium. Dielectric inks may be used to print electrically insulating structures. Dielectric inks may include polymers or ceramics, dispersed in a liquid medium. Hybrid inks may combine more than one functionality into a single ink formulation.

Property sensors as described herein may be used to sense properties of a fluid resulting from a mixing process. They may also be used to sense properties of input fluids for a mixing process or for an industrial manufacturing process. Advantageously, separate property sensors for respective input fluids are placed just in front of the mixer. Data from these property sensors measuring the input fluids can be processed along with data from a property sensor measuring the mixed fluid, e.g. in an integrated materials property monitoring system. Where, for example, a fluid composition is mixed from three input fluids, a property of each of the three fluids before mixing can be determined using three property sensors at the respective outlets of the three containers containing the three input fluids. This may help in quality control and reduce waste that might otherwise occur due to one of the input fluids being outside a specification for the property.

Sensors described herein may determine various properties of a fluid, like, for example, mixing ratio of a two-component adhesive or curing status of a curable composition or ageing status. The number of properties which were varied previously to establish the set of calibration data representing calibration impedance responses measured previously at the different property values determines the number of properties that can later be determined by the property sensor. The pre-stored set of calibration data representing calibration impedance responses measured previously at the one or more sensing frequencies and at different property values of a property of the fluid forms, or represents, a multi-dimensional data field which is specific for the fluid. This data field allows the property value deriver to determine, from a response impedance actually measured, a value of the property of the fluid.

A fluid has many properties: for example, viscosity, density, color, content of volatile components, water content, chemical composition, boiling point, but also ageing status, curing status in case of fluid curable compositions, or mixing ratio in case of the fluid being a mixture, to name only some.

Further, certain properties of certain fluids, however, vary with time and/or with other parameters such that the response impedance in a property sensor described herein varies with time and/or with the other parameters, too. Values of these properties may be derived via sensors and systems described herein. Additionally, variation with time includes variation of the property between different production lots of the fluid. The property sensor described herein can thus be used to detect differences in a certain property (e.g. chemical composition) of a suitable fluid between a later production lot and an earlier production lot of the fluid.

The term “property” of the fluid, according to the present disclosure, is not particularly limited. For example, as described in embodiments herein, one property of interest is a mixing ratio of two or more components of the fluid. In certain of these embodiments, the fluid is a two-component adhesive, and a property of the fluid is a mixing ratio of the components. In other embodiments, a property of interest is a curing degree or a curing status. In certain of these embodiments the fluid is a curable composition, and a property of the fluid is the degree of curing of the composition.

In other embodiments, a property of interest is an ageing degree or an ageing status. In certain of these embodiments the fluid is an ageing fluid, i.e. a fluid in which certain characteristics change over time once the ageing fluid has been created. The property sensor may determine a change in the response impedance of the ageing fluid after some ageing, compared to response impedances of an identical fluid recorded before ageing and at certain times after ageing. The property sensor may thereby determine an ageing degree or an ageing status of the fluid.

A property of the fluid may take different values, such as, for example, a property “dynamic viscosity” of the fluid “water” can take values like 1.30 mPa·s or 0.31 mPa·s. Such values are referred to herein as property values. Certain properties may not be related to only numerical property values. A property “curing degree”, for example, may have property values like, for example, “uncured”, “partially cured” or “fully cured”. A property “curing status”, for example, may have property values like, for example, “uncured” or “fully cured”. A fluid according to the present disclosure may be a viscous fluid. Independent of its viscosity, the fluid may be a flowing fluid. The fluid may be a continuously flowing fluid.

In certain embodiments, a fluid is a fluid adhesive. In certain of these embodiments, a fluid is a curable fluid adhesive. In certain of these embodiments, a fluid is a curable two-part fluid adhesive. “Two-part” refers to the adhesive being composed of a first component and a second component which are mixed, e.g. in a static or dynamic mixer, to form the adhesive.

In other embodiments, the fluid is, or comprises, a void filler, a sealant, a dielectric fluid, a thermally conductive interface material such as a thermally conductive gap filler, or a fluid chemical composition to produce any of the aforementioned fluids.

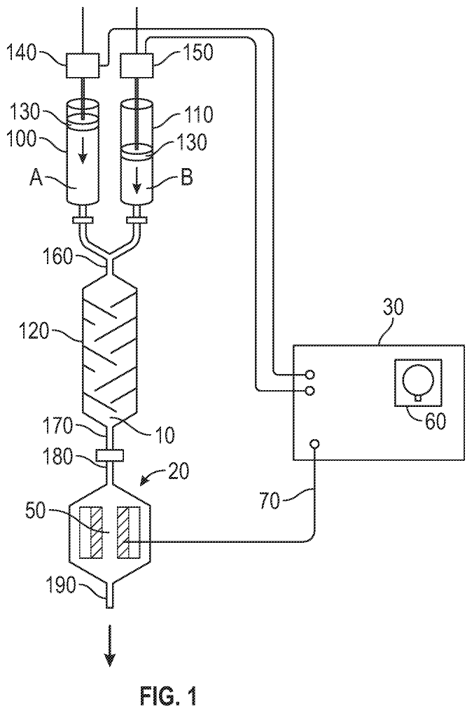

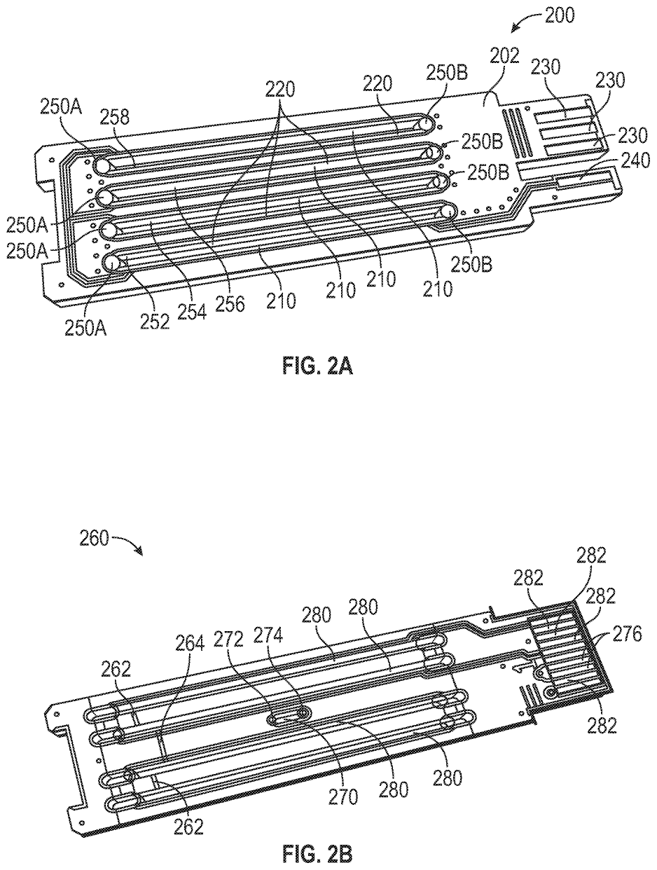

FIG. 1 illustrates an adhesive dispenser in which example embodiments can be implemented. FIG. 1 is a side view of a dispenser and mixing system for a viscous two-component adhesive. First component A and second component B of the adhesive are pushed out of respective cartridges 100, 110 into and through a static mixer 120. In the illustrated system, at the output 170 of the static mixer, the mixed adhesive passes through a sensing area 50 before being dispensed at the output 190. Sensing area 50 may house a sensor that senses a mixing ratio of components A and B in the mixed adhesive, such as sensor 200 or 260 illustrated in FIGS. 2A-2B.

The cartridges 100, 110 contain the viscous components A and B, respectively. A respective piston 130 is moved further into the cartridge 100, 110 and pushes the component A, B out. The pistons 130 are driven by respective motors 140, 150 which are individually controllable, and the pressure generated by the pistons 130 moves the unmixed components and—after mixing—the mixed viscous adhesive 10 through the static mixer 120 and the channel 20 of system. The motors 140, 150 may be part of a feedback loop: if a sensed mixing ratio is outside an acceptable band of desired mixing ratios, the motors 140, 150 can be individually controlled such as to push more of component A and/or less of component B (or vice versa) into the static mixer 120 in order to adjust the mixing ratio towards the desired mixing ratio. Both motors 140, 150 can be controlled separately to obtain a desired total throughput per second of mixed adhesive to be dispensed.

The static mixer 120 receives the unmixed components A and B of the two-component adhesive at an input end 160. Lamellae inside the static mixer 120 redirect the flow of the input materials many times and introduce shear forces that help mix the components A and B with each other. The output end 170 of the static mixer 120 is connected to an inlet 180 of a duct piece 20 (shown in longitudinal sectional view) containing a channel and sensing zone 50. The mixed adhesive 10 can thus exit the static mixer 120 and enter the duct piece 20. At the outlet 190 of the duct piece 20, the mixed adhesive is dispensed.

Within sensing area 50 may be a sensing system that is communicable, for example via wires 70 to a computerized control system 30, which provides an AC voltage to generate a required electric field needed for measuring conductivity using a suitable sensing system, such as that described herein.

The computerized control system 30 has an internal data storage device 60, on which a set of calibration data representing calibration impedance responses is stored. These calibration impedance responses may have been previously recorded, i.e. before the measurements, in a calibration process using the same duct piece 20 and identical components A, B resulting in an identical mixed viscous adhesive 10. During the calibration process the mixing ratio A/B was adjusted to certain fixed calibration mixing ratios (CMR), and for each of these calibration mixing ratios the calibration impedance response (CIR) was sensed at five different calibration sensing frequencies (CSF). These data sets, e.g. in the form of triples of (CMR, CSF, CIR), are recorded and stored in datastore 60. They form a three-dimensional data field, which is specific for the viscous adhesive. The data sets are used to build a parametrized multi-dimensional model, based on multi-dimensional polynomials, of the data sets. This parametrized model facilitates quick interpolation by a computer between individual data sets and quick derivation of a property value of a property of the fluid in the subsequent measurement. The parameters of the parametrized model form a set of calibration data which represents the data sets recorded during the calibration process.

Later, when running an actual measurement of the value of the property “mixing ratio” of a viscous two-component adhesive of components A and B in the system illustrated in FIG. 1, the measured impedance responses (MIR), each measured at certain measurement sensing frequencies (MSF), are recorded in the control system 30. In order to derive a value for the mixing ratio from the measured impedance responses at the measurement sensing frequencies, software running on the control system 30 identifies, within the set of calibration impedance response triples, those triples having the closest calibration response impedances, closest to the measured impedance responses, and the closest calibration sensing frequencies, closest to the measurement sensing frequencies. This identification and a potential interpolation can be performed easily by using the parametrized multi-dimensional polynomials modelling the plurality of data sets, i.e. the plurality of triples of (CMR, CSF, CIR). From those calibration data, the software derives a value for the (sofar unknown) mixing ratio in the actual measurement.

The same sensing frequencies used for calibration will often be used also for the measurement. There may, however, occur a mixing ratio in the measurement for which no calibration impedance response had been determined in calibration. So there may be not an exact match in both sensing frequency and response impedance between a triple in the calibration data set. In such a case, an interpolation between two suitably chosen calibration triples, containing two calibration impedance responses close to the measured response impedance, yields an interpolated calibration mixing ratio which can then be considered the mixing ratio in the measurement. The interpolation is performed by software on the control system 30, using the parametrized multi-dimensional polynomials.

The result of the interpolation and derivation is a value of the mixing ratio of components A and B in the mixed two-component adhesive 10 in the sensing zone 50 during the measurement.

The calibration impedance responses can be measured by their dependence on two parameters, namely on the sensing frequency and on the mixing ratio. In other embodiments, dependence of impedance responses on further parameters may be taken into account, such as, for example, dependence on the temperature of the adhesive in the sensing zone. A data set of the calibration impedance responses would then be a quadruple of values, such as (CMR, CSF, CIR, Temperature), and the pre-stored set of calibration impedance responses would be a set of quadruples forming a four-dimensional data field, which is specific for a viscous adhesive, for example. Taking further parameters into account could make a data set be a quintuple of values, or high-order tuples of values, so that the data sets of calibration impedance responses is a multi-dimensional data field of more dimensions and can be represented by different parametrized multi-dimensional polynomials.

Control system 30 may record the values for mixing ratio, with a time stamp, for quality assurance. In the illustrated system, motors 140, 150 pushing the respective components A and B into the static mixer 120 are connected to, and controlled by, control system 30. The mixing ratio derived during the actual measurement is checked continuously against a desired mixing ratio. If its deviation from the desired mixing ratio is larger than acceptable, control system 30 may change the speed of one or both of the motors 140, 150 suitably to adjust the measured mixing ratio towards the desired mixing ratio. While motors 140, 150 are illustrated, it is expressly contemplated that systems and methods herein may also apply to compressed air operated dispenser systems, hydraulic systems, cavitation-based systems, precision gear-based systems, peristaltic pump-based systems, or other suitable dispensing systems.

FIG. 1 illustrates an example system where a sensing area 50 is located after the mixer 120. However, it is expressly contemplated that, in some embodiments, a sensing area 50 may be positioned before mixer 120, for example positioned to measure a parameter relevant to only material A or B, or elsewhere in the system, for example within mixer 120 to measure a mixing progress.

Having a sensor in a sensing area can provide a snapshot of fluid conditions. Systems and methods provided herein, and discussed in FIGS. 2-10, provide a fuller picture of fluid flow conditions while fluid is flowing, and when it is not. A single PCB serves as housing for both positive and negative electrodes along one or more slits. This provides multiple benefits including pressure independence—the sensor requires optimization to handle pressure changes in a housing and bending of PCB boards under fluid pressure. The pressure drop experienced across the thickness of a PCB board, instead of the width, will only have a minor influence. Similarly, the temperature dependency is also lower as PCB material is already optimized for electronics with a low thermal coefficient of expansion.

FIGS. 2A-2B illustrate material measurement flow sensors in accordance with embodiments herein. FIG. 2A illustrates a PCB material measurement flow sensor 200. As illustrated in FIG. 2A, a sensing system 200 includes a PCB board 202 with one or more grounds 230 and a TX contact 240. The TX contact provides a transmitting signal to each transmitting electrode 210. Four RX contacts (not shown), located on the reverse side of the PCB, receive the indication of a sensed impedance from each of the electrode pairs. The electrical potential of each receiving electrode 220 is electronically regulated to ground potential separately. The regulator action for each receiving electrode, in some embodiments, is interpreted as an impedance signal for each electrode pair. In the illustrated embodiment, four separate measurements channels can provide information, each through its own TX contact 240 and RX contact (not shown).

In the illustrated embodiment, a sensing system 200 has four electrode pairs, with four transmitting electrodes 210, each paired with one of four receiving electrodes 220. However, it is expressly contemplated that more, or fewer, electrode pairs may be present, depending on available area on a PCB board and sensing needs.

Each of the electrode pairs are decoupled from the adjacent pair such that four separate conductivity measurements are received, one from each electrode pair 210, 220. Sensing system 200 is placed, in some embodiments, perpendicularly to the flow of material, such that a first sensing area 252 receives a first portion of material flow, a second sensing area 254 receives a second portion of material flow, a third sensing area 256 receives a third portion of material flow, and a fourth sensing area 258 receives a fourth portion of material flow. Therefore, system 200 can simultaneously generate four different signals relative to a single material flow, providing a better picture of whether a mixing ratio (or other measured parameter) is consistent across an entire sensing area.

FIG. 2A illustrates an embodiment where each electrode pair is part of a slot 252, 254, 256, 258. However, it is also contemplated that, instead of being closed on both sides, a sensing area may include a pair of electrodes on a protrusion, or within an aperture, in a “comb”-like structure. However, it may be preferred for both ends to be closed from a structural standpoint, especially with viscous fluids.

As described further herein, the electrodes 210, 220 may be formed by metallization on the interior surface of slides 252, 254, 256, 258, using copper for example. The metallization process may cause electrodes 220 to be connected to electrodes 210. Therefore, a decoupling or disconnecting step is needed. This can be done by breaking the connection, for example by drilling a hole in the positions 250A and 250B as illustrated, by punching out a perforated component, milling, nibbling, etching, laser cutting or another suitable method.

Systems and methods herein may be used for a variety of materials being dispensed. PCB boards often have a maximum operating temperature less than 170° C., which limits the temperature of materials that can be dispensed through a sensor system 200. Materials may have a range of viscosities, for example up to around 105 Pas. Higher viscosity might result in a dispensing pressure being insufficient to force the material through slots 252-258 without breaking the sensor. However, higher viscosity materials may be accommodated by increasing the width of slots 252-258. However, sensing system 200 may be less sensitive. Similarly, for materials with particulates, such as suspensions for example, particle sizes have to be smaller than the width of slots 252-258. Additionally, systems herein may be limited to solvents that do not cause corrosion or otherwise damage the PCB 202 or electrodes 210, 220.

FIG. 2B illustrates another embodiment of a sensing system 260, which includes a built-in temperature sensor 270. Temperature sensor 270 sits within a slot with a connection point 272 for a ground signal and a connection point 274 for a temperature signal. Ground signal connection point 272 connects to a ground signal communicator 282. Temperature signal communication point 274 connects to a temperature signal communicator 276. Similar to the embodiment of FIG. 2A, four impedance or conductivity sensor slots 280 are also present, each connected to a ground signal 282. However, it is noted that two different spacings between slots are present in the embodiment of FIG. 2B. A first spacing, 262 is present between a first and second slot 280, and between a third and fourth slot 280, while a second spacing 264 is present between second and third slots 280. Increased spacing 264 may provide improved shielding against interference between electromagnetic fields generated by each electrode pair.

Many mixing processes are at least partially temperature dependent, with material properties like viscosity changing with temperature. Temperature sensors inserted from an external point are often fragile and need to be in the middle of the flow of the material being tested. In the embodiment of FIG. 2B, a temperature sensor is sealed within a housing, which keeps it isolated from the material. The seal layer may be a layer of varnish, for example, which may allow for the thermal contact to be improved relative to other housing materials. As illustrated, the temperature sensor connects via contacts 282 on the edge connector.

FIGS. 2A-2B illustrates an embodiment where slots 252-258, 270 and 280 are ovular in shape, with a generally straight body and rounded ends. However, other configurations are possible. Electrodes 210, 220 may be curved, for example, or otherwise shaped to accommodate an available volume of a dispensing system.

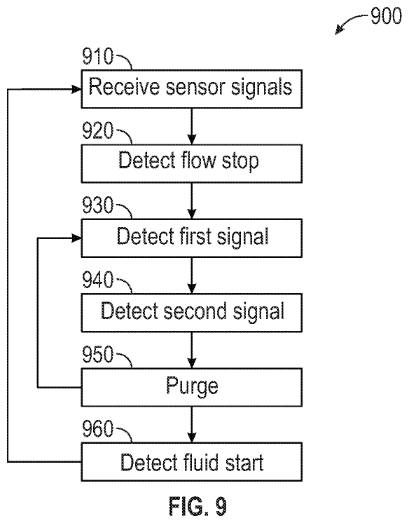

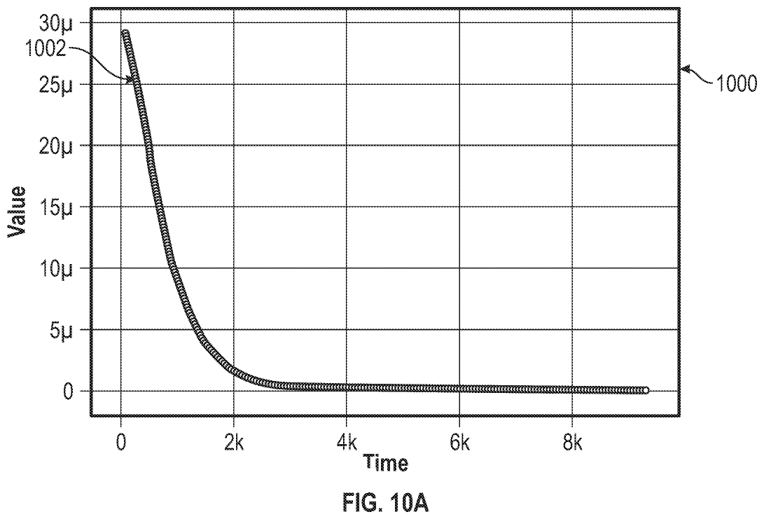

FIGS. 2A-2B illustrate two example embodiments of a sensor construction with four electrodes in parallel. However, it is expressly contemplated that other electrode configurations are possible. For example, slots 252-258 may vary in length or thickness, spacing apart from one another, or in number. For example, by reducing a length of slots 252-258, an 8-slot configuration may be possible by placing another set of slots next to slots 252-258, or even a 12 or 16-slot configurations. Other example configurations are described in Provisional U.S. Patent Application having Ser. No. 63/486,631, filed on Feb. 23, 2023. Other example configurations are also illustrated in FIGS. 9-11, 13-14, 16-18 of Provisional U.S. Patent Application 63/507,662, filed herewith. FIGS. 9-11, 13-14 and 16-18 of said application, along with the accompanying description, are incorporated by reference herein.

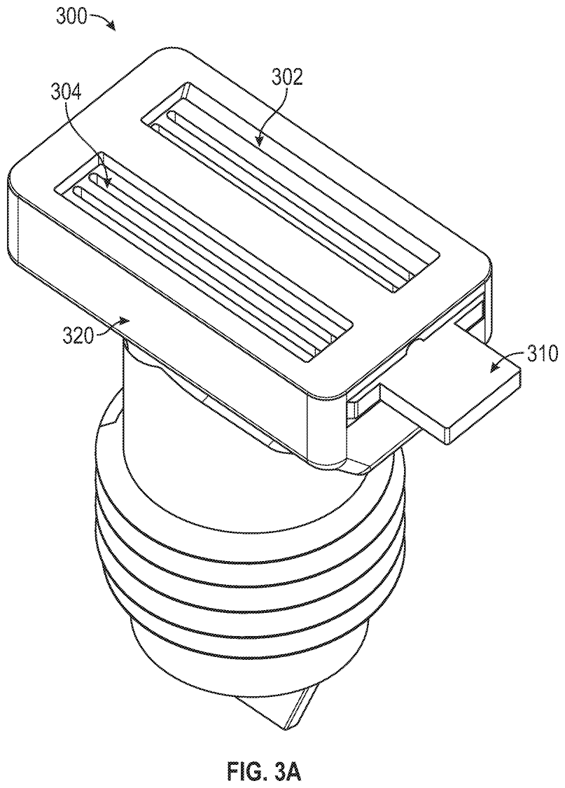

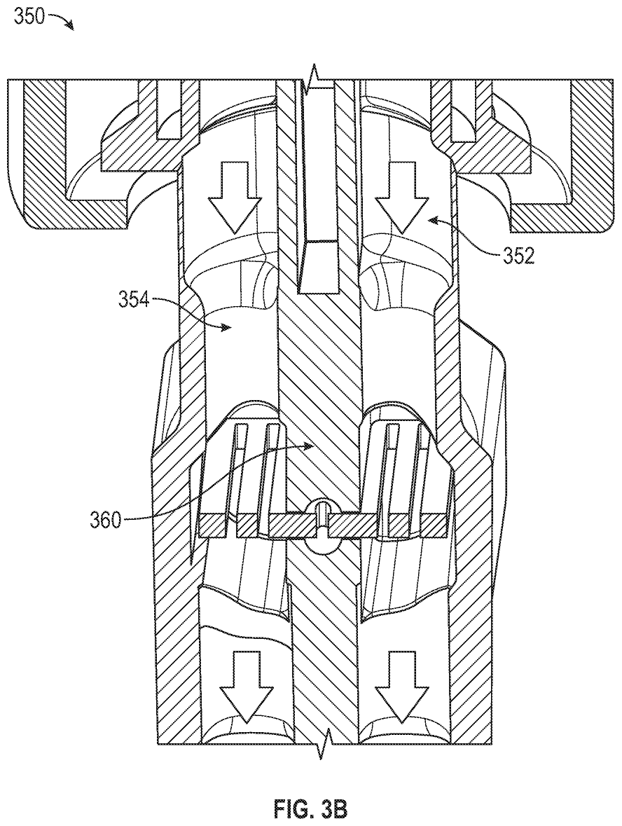

Referring back to FIG. 1, a sensing area 50 may receive fluid from an inlet 180, and provide fluid through outlet 190. FIGS. 3A-3B illustrate an example configuration of a sensing system that may be used in sensing area 50. Sensing system 300 may be useful for dispensing systems that dispense a 2-part mixture, e.g. a Part A and a Part B. Sensor 310 may reside in a sensor housing 320, in some embodiments. Housing 320 may removably receive sensor 310, such that sensor 310 can be replaced after a dispensing operation, or when adhesive curing occurs within housing 320. In some embodiments, housing 320 is configured to be replaceable after a dispensing operation.

Sensor 310 can be used to verify a material, for example by comparing actual conductivity values to expected conductivity values. For example, values from a previous lot may be compared to currently sensed values to determine quality of a new bath of material. Lot to lot variation may therefore be captured. Additionally, values may be compared from operation to operation to detect aging or other factors that may change how Component A may vary over time. Sensor 310 may be connected to a control system which may provide an indication to an operator if sensed conductivity values are outside of an expected range. Sensor 310 includes a plurality of slots that are angled perpendicular to the flow of the mixed material. Sensor 300 may provide a number of indications, including mixing ratio indications, curing indications, and other information relevant to the quality of mixing. While sensor 300 is illustrated as perpendicular to flow of a material, it is expressly contemplated that other angles may be possible. In some embodiments, any non-parallel configuration is suitable. In some embodiments, an acute angle between sensor 310 and fluid flow is preferred. In some embodiments, an obtuse angle between sensor 310 and fluid flow is preferred.

As illustrated in FIG. 3A, a housing 320 may receive an incoming material. Because each of the apertures of a PCB-based sensor herein can be decoupled from each other, it is possible to use a single sensor 310 to take conductivity measurements from two different materials. In the embodiment illustrated, a first channel 3022 receives a first component and a second channel 304 receives a second component. While only two component channels are illustrated, it is expressly contemplated that a third channel could receive a third material, etc. Similarly, while two slots are illustrated in each channel of FIG. 3A, it is expressly contemplated that more, or fewer, may be present in other embodiments.

FIG. 3B illustrates a cutaway view 350 of the system of FIG. 3A. As illustrated, channel 352 receives a Component A and provides it to one or more electrode pairs, through which it flows. Similarly, channel 354 receives a Component B and provides it to one or more other electrode pairs, on the same PCB sensor. Components A and B may flow through a housing with a wall 1276 preventing premature mixing.

However, while FIGS. 3A-3B illustrate a configuration that receives two components pre-mixing, it is expressly contemplated that such a system could be used in sensing area 50, with or without wall 360, such that a fluid mixture flows through slots in sensor 310.

In some embodiments herein, a pressure sensor is connected to an exterior of a positive displacement pump. In some embodiments, the pressure signal is captured in amperes. It can be converted to voltage before being provided to an analyzer for analysis. In real-time, in some embodiments, a conductivity, a temperature and a pressure signal can be captured simultaneously.

A fluidic system signal pressure may be measured in amperes, voltage or another suitable unit. The ampere measurement may be converted to voltage, for example using a signal NI box converter or another suitable system. The pressure signal can be provided as a digital signal such that it can be analyzed by an analyzer, and used to provide a real-time understanding of pressure in the system. However, it is expressly contemplated that other signal units may be used for analysis, e.g. without converting to voltage. Using current may preserve fidelity of the signal at initial measurement. However, it is expressly contemplated that other methods may be used to retrieve a pressure signal in-situ.

Described herein are a number of sensor configurations that may be used in a variety of dispensers. However, it is also noted that, with sensors herein, a modular dispenser may be used.

While conductivity is discussed herein as the value of interest, it is expressly contemplated that other material parameters, such as the amount of electrical current and the relative permittivity (er), could be used instead or as well for the detections algorithm.

Described herein thus far are sensor systems that are based on a single PCB board. Such systems are relatively inexpensive and, therefore, cost effective to use and replace. However, one disadvantage of designs described thus far is the large stray field compared to the main field present between each electrode pairs. The stray field effect is caused by the short distance between material flow input and output, e.g. the thickness of the PCB. One way to reduce the stray field effect is to solder multiple PCBs, each with electrode-containing apertures, into a PCB stack.

Sensing systems herein are designed to analyze conductivity (or another suitable parameter) and, provide substantially real-time feedback when a change in flow is detected.

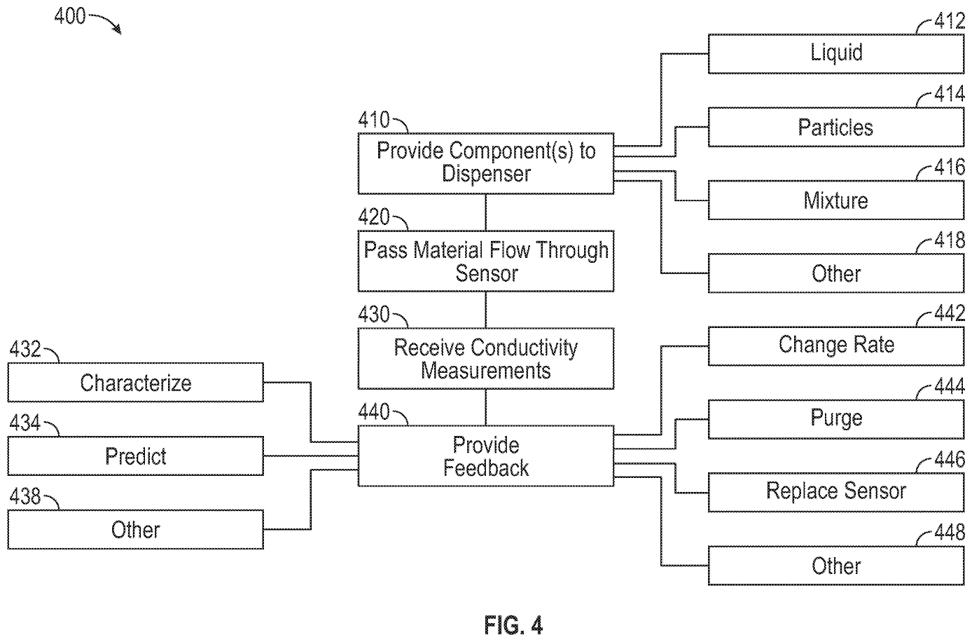

FIG. 4 illustrates a method for controlling a material dispensing system in which embodiments herein may be useful. Method 400 may be used with the dispensers described herein, or another suitable sensing system.

In block 410, one or more components to be dispensed are provided to a dispenser. For example, a dispenser may dispense a liquid 412, particles 414, either in suspension or otherwise. The material may also be a mixture 416 of components. For example, an adhesive may be formed of an A and B component provided at a desired mix ratio. Other components 418 may also be provided to a dispenser for dispensing.

In block 420, during dispensing, the material passes through a sensing system prior to being dispensed onto a worksurface. Passing through a sensing system may entail passing through a portion of a sensing body such that the material directly contacts an electrode, as illustrated in FIGS. 3A-3B, or otherwise described in FIGS. 9-11, 13-14, 16-18 of Provisional U.S. Patent Application 63/486,631 filed herewith, said figures and accompanying description being incorporated by reference herein. For conductivity sensors, direct contact between a material and an electrode pair ensures accurate measurements.

In block 430, conductivity measurements are received from the sensing system. The sensing system may have multiple sensors, for example a plurality of electrode pairs that, when a sufficient voltage is passed through them, detects a conductivity of the material. Based on the conductivity readings, a number of things may be determined for the material. For a mixture, a mixing ratio may be determined. For a curable material, a curing progressing may be detected. Aging may also be detectable, as well as differences between batches of materials. Entrained air may also be detectable. Conductivity measurements may be taken serially, for example one signal received every second, or more frequently. Conductivity measurements may also be taken in parallel, for example from each of a plurality of electrode pairs. The electrode pairs may be coplanar with each other, in some embodiments.

Additionally, flow of fluid itself can be detected. For example, it may be possible for a sensing system to detect, based on a change in conductivity signals, that fluid flow has stopped, or re-started. This may be of particular usefulness for determining when a purge of the dispensing system is needed, as discussed in greater detail below.

In block 440, feedback is provided based on the conductivity measurements. Feedback may include characterization of the material, as indicated in block 432. For example, a mix ratio may be detected, or entrained air, or an age indication may be provided. A prediction may also be provided, as indicated in block 434. For example, based on a trend of previous conductivity sensor readings, it may be possible to predict future behavior. A conductivity reading trending in one direction may indicate that a mix ratio is moving toward an edge of an acceptable range and, therefore, that a mix rate should be changed, as indicated in block 442. Similarly, a conductivity reading may indicate that a curable component is curing. Feedback may therefore indicate that a purge of one component, multiple components, or a mixture, is needed, as indicated in block 444. In embodiments where a material has corrosive effects, or cures over time, predictive feedback may provide an indication that the sensor needs to be replaced, as indicated in block 446. Other predictive information may also be provided, as indicated in block 438, that may trigger other actions, as indicated in block 448.

In some embodiments, as illustrated herein, providing feedback may also include providing conductivity readings, material characterizations or predictions to a customer, controller of a dispenser, or other useful information such as material source, batch number, material name, dispensing temperature, dispensing pressure, material concentration(s), mix ratio, or any other information.

FIG. 1 illustrates a dispenser that dispenses a mixture of two components. In between dispensing operations, material may sit in a dispenser—for example after a dispensing operation on a first worksurface, while a second worksurface is being set up. In the case of adhesives or other components that experience curing, it may be necessary to purge the system so that the material does not cure enough to be unusable, and potentially cause system damage. Purge thresholds, or a time after dispensing stops before a purge should be initiated, may be set based on when a material or mixture will have cured either past the point of being useable or past a threshold safe for dispensing machinery. Thresholds may be set by a manufacturer of components, a curing profile, or another source. When a sensed conductivity reaches a threshold after an operation, a purge can be indicated or, in some embodiments, automatically initiated. Purging can include, for example, pushing one or both components through a mixer until all of the previously mixed components are flushed through the system. During a purge, the one or both components being purged are mixed in the mixer, but not completely cured. Once a purge is complete, a purge clock can be started again, such that a second purge is initiated if a purge threshold is reached a second time.

Currently, purging is often a manual process. When fluid flow stops, a purge clock must be started. While some control systems exist that set a purge clock based on an indication of dispensing/not dispensing, it has to be enabled, and does not consider any material conditions. Systems and methods herein do not require a dedicated controller and can factor in real-time conditions.

For example, a particular adhesive mixture may experience sufficient curing within 5 minutes that the system requires purging before the next operation. So, when flow of said mixture stops, a purge clock needs to start and, if five minutes pass before a next operation starts, a purge needs to be conducted. Operators of a dispensing operation must manually record flow starts and stops, whether and when a purge is conducted, and when the purge is complete.

As sensing systems are increasingly automated, it is desired to detect when fluid flow stops and re-starts. Detecting when fluid flow stops is helpful for accurately starting a purge clock, and accurately detecting fluid flow re-starting can ensure that a purge clock is stopped when purge is started.

Additionally, it is helpful to both track system parameters in real-time so that flow changes can be detected and issues remedied quickly. For example, while a purge threshold may be set to 10 minutes for a particular adhesive, dispensing conditions (e.g. temperature, age of materials, contaminants, etc.) may actually cause curing to proceed faster, such that material becomes unusable at 8 minutes and damage to the machine is possible at 9 minutes. Therefore, following the purge threshold manually can cause problems when the dispensing conditions are not understood in real-time.

Systems and methods herein provide for real-time tracking of materials within a dispensing system. Systems and methods herein help to ensure that materials are dispensed or disposed of before they are no longer suitable for use and/or before they could damage a dispenser.

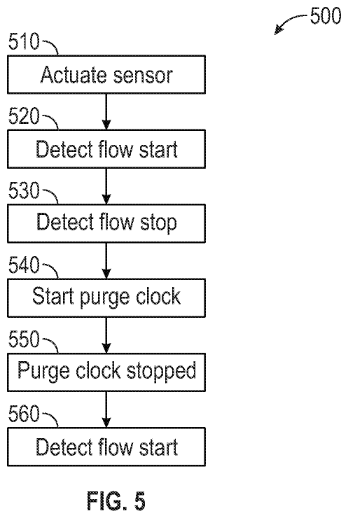

FIG. 5 illustrates a method for automatically purging a dispensing system in accordance with embodiments herein. Method 500 may be useful for accurately starting a purge clock after fluid flow is stopped, and for accurately stopping the purge clock after fluid flow starts again. While a human can easily see that a fluid is, or is not, flowing from a dispenser, it is difficult to determine fluid flow using in-flow measurement systems. Because an in-flow sensor is in contact with a fluid in the dispenser during flow, and when flow is temporarily stopped, it is difficult to distinguish the difference. Parameter measurements (e.g. conductivity, impedance, dielectric constant) over time look very similar. Analysis and detection of flow stops and starts must also happen quickly so that purge timing is accurate, and so that a purge clock stops when flow re-starts.

Further, a method for detecting flow starts and stops is desired that is not material specific. For example, epoxies, acrylics and urethanes all have different material chemistries and behave differently, with different ranges of mix ratios, dispensing speeds, and water contents. It is important that a method for flow detection be generalizable and not specific to these factors.

At block 510, a sensor or sensing system is actuated. A sensor may be placed in direct contact with a fluid flowing through a dispenser in some embodiments herein. Fluid may flow through a sensor, for example through one or more apertures in a sensor. Fluid may flow through the sensor at an angle, in some embodiments herein. However, sensing systems herein may receive sensor signals from a sensor that indirectly contacts a fluid, in some embodiments herein. Actuating a sensor may include turning on, or powering up, a power source of a sensing system. Actuating a sensor may include connecting one or more leads to a physical sensor. Actuating a sensor may include placing a sensor in a housing that couples to, or is received by, a dispensing system.

At block 520, fluid flow through the dispenser is detected. Detecting an initial start of fluid through the dispenser is easier than detecting flow starting after a previous stop, e.g. detecting that fluid sitting in the dispenser, in contact with a sensor, has started moving again.

At block 530, a stop in fluid flow is detected. Fluid flow may stop for a number of reasons—to troubleshoot an issue with a dispenser, to remove a completed workpiece and place a new workpiece, for workers to take a break or address other issues, etc. It is important to accurately calculate a fluid flow stop in the event that a worker fails to accurately note when fluid flow stopped. As noted previously, sufficient curing can occur within minutes to make fluid in a dispenser unusable, or to damage the dispenser. Additionally, as noted below, because a time to purge changes based on ambient and dispensing conditions, accurately measuring when flow stops is important to ensure that fluid flow quality is maintained.

At block 540, a purge clock is started. Based on a known identification of a material in a dispenser, a purge time threshold can be retrieved, and a purge clock started. For example, a first material may have an 8 minute threshold of non-flowing before a purge is indicated, while a second material may have a 6 minute threshold. Each threshold may be temperature dependent, or dependent on other dispensing or ambient factors. So, it is important to start or base the purge clock on the detected stop. Additionally, it is important that detection of a flow stop is done efficiently enough that a purge can be completed within the threshold time—e.g. within 8 minutes for the first material or within 6 minutes for the second material.

At block 550, a purge clock is stopped. A purge clock can be stopped because a purge has initiated or completed. While only a single purge clock stop is illustrated in method 500, it is expressly contemplated that the steps of blocks 540 and 550 may repeat on a loop until a new dispensing operation starts. E.g. if 20 minutes goes by between a first dispensing operation and a second dispensing operation, the first material may undergo a purge twice.

At block 560, a re-start of fluid flow is detected once the purge is completed. Detecting a re-start in fluid flow is important to ensure that a purge clock is stopped, and a purge is not automatically triggered during a dispensing operation.

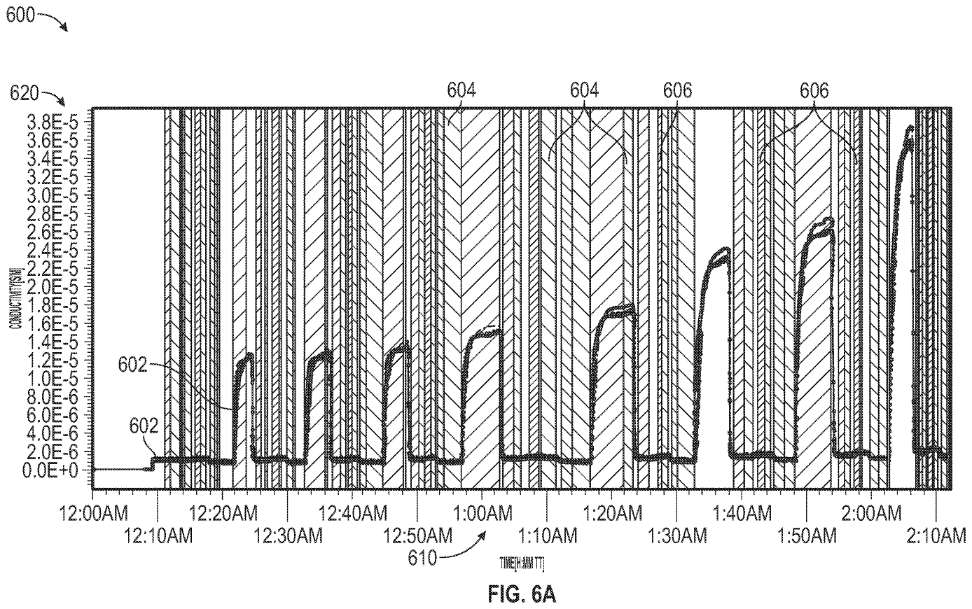

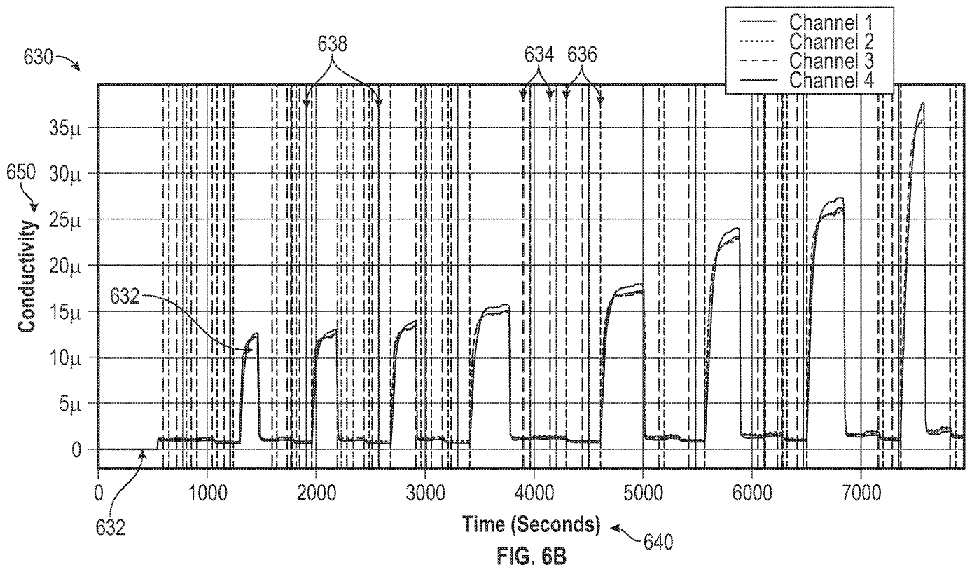

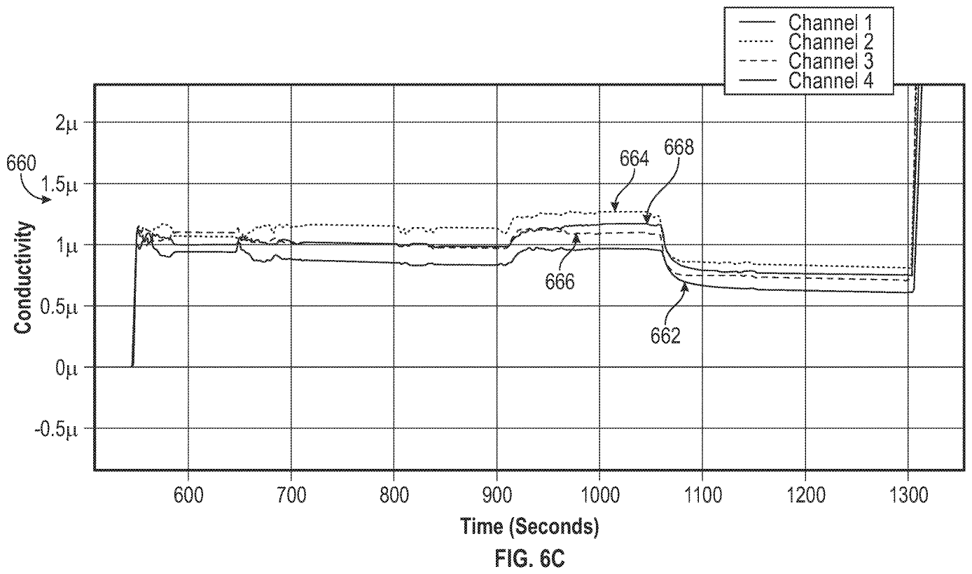

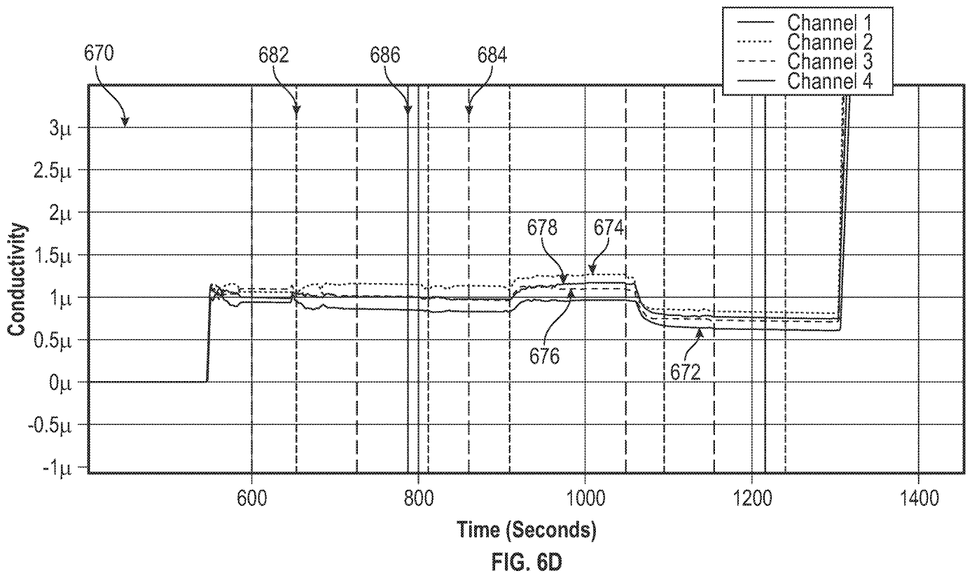

FIGS. 6A-6D illustrate conductivity tracking examples in accordance with embodiments herein. FIG. 6A illustrates a graph 600 of conductivity 602 for a dispensing operation taken over a period of time, with conductivity 620 on the Y-axis and time 610 on the X-axis. Graph 600 has been manually tagged with information about fluid flow based on dispensing notes taken during an operation. Several flow stops 604 and flow starts 606 are illustrated. It is desired to have a sensing system that can detect starts 606 and stops 604 while a dispensing operation is ongoing. Purge timer starts 608 are also indicated.

Systems and methods for tracking fluid flow receive a live data stream of conductivity values. For example, a 4-channel sensor (e.g. as illustrated in FIGS. 2A-2B) delivers four conductivity values. A buffer stores a series of datapoints taken over time. Each datapoint may include a set of conductivity measurements including four conductivity values (from each of the channels) and a time stamp. However, while FIGS. 2A-2B illustrate a four-channel sensor, it is expressly contemplated that more, or fewer, channels may be present on a sensor in other embodiments herein. For example, a 5-channel sensor may provide five conductivity values, one generated by a set of electrodes in each of the 5 channels. Or only one, or two, or three, channels may be present, providing one, two, or three conductivity values, respectively, at each time. Or more than 5 channels may be present, such as 6, 8, 10, 12, 16, 20, or another suitable number. In some embodiments, sampling is done as frequently as once per second, or twice per second, or three times per second

The buffer stores a series of conductivity datapoints. The following analysis is done for each of the conductivity values (e.g. for each of the electrode pairs).

For each electrode, a correlation coefficient is determined using Equations 1-3.

$$var ( X ) = \frac{1}{n - 1} {\sum }_{i = 1}^{n} {( {x}_{i} - E ( X ) )}^{2} \qquad Equation 1$$

$$cov ( X , Y ) = \frac{1}{n - 1} {\sum }_{i = 1}^{n} ( {x}_{i} - E ( X ) ) ( {y}_{i} - E ( Y ) ) \qquad Equation 2$$

$$cor ( X , Y ) = \frac{cov ( X , Y )}{\sqrt{var ( X ) var ( Y )}} \qquad Equation 3$$

Which can be expressed in a single formula, Equation 4.

$$cor ( X , Y ) = \frac{{\sum }_{i = 1}^{n} [ ( {x}_{i} - E ( X ) ) ( {y}_{i} - E ( Y ) ) ]}{\sqrt{{\sum }_{i = 1}^{n} [ {( {x}_{ι} - E ( X ) )}^{2} ] {\sum }_{i = 1}^{n} [ {( {y}_{i} - E ( Y ) )}^{2} ]}} \qquad Equation 4$$

Where X is the buffered time vector, Y is the buffered electrical conductivity vector, n is the buffer size, and E is the expected value.

Generally, systems and methods herein are measuring variability within and between channels, which is different when the system is running or not running. The challenge is to detect that change in variability within a short time frame, and to isolate the indications of flow from noise in the signal. For example, an entrained air bubble passing through a sensor channel also creates variability between channels. Using a buffer, e.g. a historic dataset consisting of recent datapoints, it is possible to filter out some of the noise. The buffer may also be considered a trailing dataset. In some embodiments, two buffers are used.

The calculation using Equation 4 is determined for each buffer state with the arithmetic mean of the buffers' correlation coefficients becoming the characteristic coefficient c, as illustrated in Equation 5.

$$c = \frac{1}{n} {\sum }_{i = 1}^{n} {corr}_{i} \qquad Equation 5$$

A filter is then applied to c, resulting in Equation 6:

$$filtered\_set = \{ c \vert c < {c}_{filter} , - 1 \leq {c}_{filter} \leq 1 \} \qquad Equation 6$$

Where c_filter is a threshold value determined for each material. In some embodiments, a value of −0.9 is used. It is noted that, while a value of −0.9 may not work for all materials, it has worked well for a number of adhesives.

The state of flow in a dispensing system (e.g. stopped or started) is determined by the count of elements in filtered_set. This is a tunable parameter that may depend on the material. This parameter also does depend on the buffer size. If the size of filtered_set is above some parameter, then the system is considered stopped, and if below some other parameter, it is considered started. For example, if the buffer size is 10, the stopped parameter may be 10 (all values must indicate a stop) while the started parameter may be 2 (if any 2 samples in the buffer indicate started, but a single started signal will not trigger the stopped event).

Finally, there is a purge_timer parameter that is set to be True if some threshold time is exceeded while in the stopped state. In some embodiment, when the threshold time is exceeded, a purge indication may be generated and communicated. For example, the purge indication may be communicated to a user interface generator, which may generate a purge timer, or purge indication for a user interface. The purge indication may be communicated to a second device, for example, as a message to be read or stored. This triggers a signal to the frontend user interface to inform the user that a purge is needed at some time in the future (current concept is to display a countdown timer at this moment).

The delay between detecting a stop and generating the purge trigger indication may be so short that, for a user, it appears to happen in real-time. However, in some embodiments, the purge indication may be delayed so that indications are not prematurely generated. In one embodiment, a 1-minute delay from flow stop is present before a purge trigger indication is generated. However, it is expressly contemplated that no delay is present, and a purge trigger indication is automatically provided. Other time delays are also envisioned for other embodiments.

Conductivity is discussed herein as the parameter of interest for detecting flow starts and stops. However, it is expressly contemplated that other parameter values may be suitable-such as impedance or relative permittivity.

FIG. 6A illustrates a manually tagged graph of conductivity over time for DP (Duo pack) 460 Epoxy, available from 3M® Company, located in St. Paul, Minnesota. FIG. 6B illustrates the same graph of conductivity, with start and stop tags as detected in real-time by a flow monitoring system in accordance with embodiments herein. Conductivity values 632 from a number of electrodes in a sensing system are illustrated in graph 630, which plots conductivity 650 over time 640. The system, using the methods described herein, accurately detected and labeled flow starts 636, stops 634, and purges 638. As illustrated in the comparison between manually tagged FIG. 6A, and algorithm-detected FIG. 6B, systems using embodiments herein can accurately detect changes in flow indicative of starts and stops.

FIGS. 6C-6D illustrate the challenge of detecting a running state of a dispenser. FIGS. 6C-6D illustrate a portion of the data from FIGS. 6A-6B, e.g. only the first 1350 seconds of an operation instead of the first 8000. Conductivity graph 660 illustrates conductivity signals received from each of four electrodes (662, 664, 666, 668) over time. Some variation can be seen in the values of each conductivity signal, and different amounts of noise are present in FIGS. 6C-6D.

FIG. 6D illustrates conductivity graph 670, with flow indications detected by a flow monitoring system. Starts 682, stops 684, and purges 686 were accurately detected based on conductivity signals from four electrode pairs of a sensing system-signals 672, 675, 676, and 678.

The algorithms described herein for detecting flow stops and starts have been found to work for a wide range of adhesives, including epoxies, acrylics, and urethanes. The algorithms described herein were successfully tested on a range of material ages, water contents, dispense speeds and mix ratios. The algorithms described herein are independent of a dispenser type. The algorithms herein were also successfully tested using a single-electrode sensor.

While stops and starts of flow of a mixture are described herein, it is also expressly contemplated that purge flow can be detected—e.g. as either a Part A or a Part B used to purge a dispenser will have a different conductivity than that of a mixture.

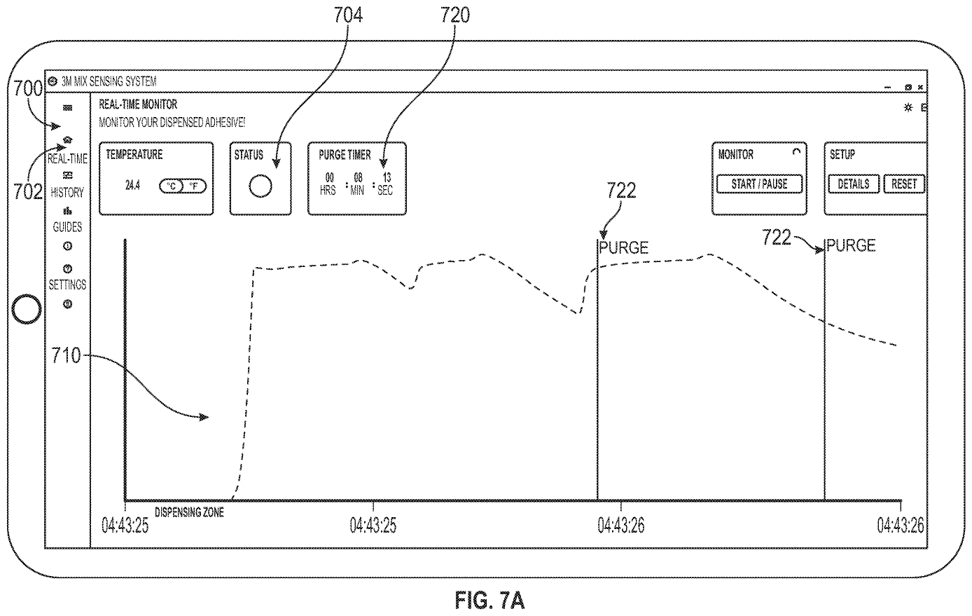

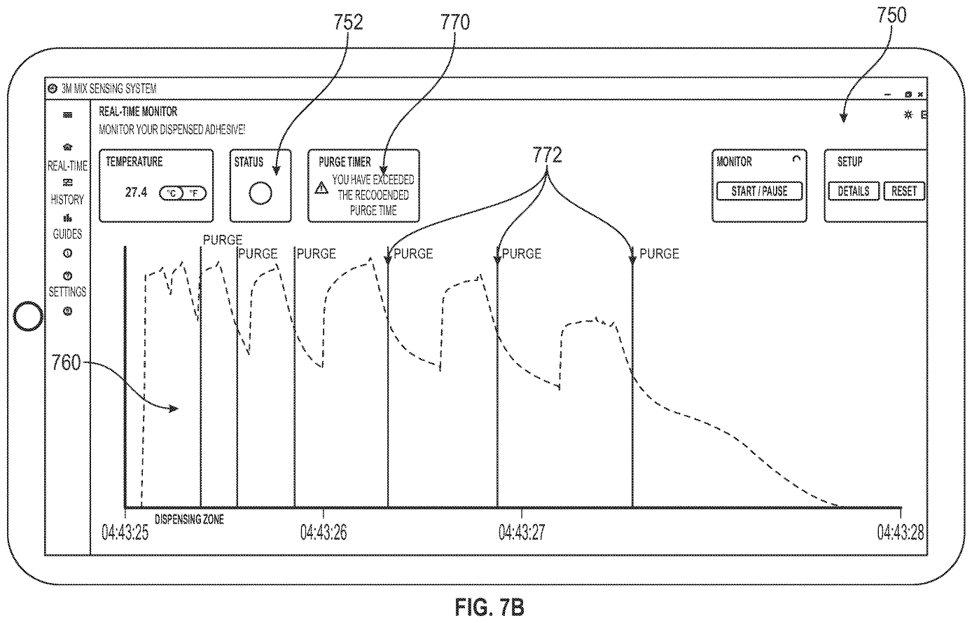

FIGS. 7A-7B illustrate example user interfaces generated by a dispenser control system in accordance with embodiments herein. FIG. 7A illustrates a user interface generated for display on a user interface 700 of a device. While device 700 is illustrated as a tablet, it is expressly contemplated that other display components may be used, such as computer monitors, television screens, projection systems, or other mobile computing devices. User interface 700 illustrates conductivity measurements 710 as they are captured in real-time, e.g. in a real-time monitoring mode 702. A flow status 704 is provided, indicated by a color in user interface 700. However, other indicia, such as alphanumeric text, is expressly contemplated. Because a stop in flow has been detected, a purge timer 720 has started running. The system has previously needed to be purged twice, as indicated by purge indications 722. FIG. 7A illustrates an embodiment where only historical purge indications 722 are displayed. However, it is expressly contemplated that flow starts and stops may be displayed in accordance with embodiments herein.

FIG. 7B illustrates a user interface 750 on a device that shows a historic view 760 of conductivity signals after a dispensing operation has completed (indicated by the conductivity returning to zero). A flow status 752 and a purge timer 770 are illustrated. However, it is expressly contemplated that, in some embodiments, purge timer 770 only appears while material is being dispensed and/or after a stop has been detected. As indicated previously, purge timer 770 may start a count down, or be provided on user interface 750, after a set delay time. Historical purges 772 are indicated.

FIGS. 1-7 describe the problem of detecting a running state of a dispensing system, which is important for accurately starting a purge timer. As described herein, however, the time between a flow stop and when a purge must occur changes based on ambient conditions, material age, etc. Currently, determining when a purge is needed is to set a timer when dispensing stops and purge when the timer runs. The timer is often set conservatively such that the dispenser is not damaged. However, using a conservative value will result in excess purging, or even continuous running. This results in significant waste of material, which, once cured, is often not useable for other applications and is thrown out.

If the timer is not set conservatively, and an operator waits too long to purge, it can take time to determine that an issue has occurred. Cured materials may build up in the static mixer, or on a sensor itself. Eventually, cure build up causes a line blockage, which requires replacement of a mixer and downstream hardware, which is also expensive and results in waste.

A purge timing system is desired that can, based on known parameters, determine an accurate purge timer, e.g. an accurate time before purge must occur. It is desired that the purge timing system calculate a purge timer in real-time such that, once a stop is detected, a timer starts with enough time left that a purge can occur.

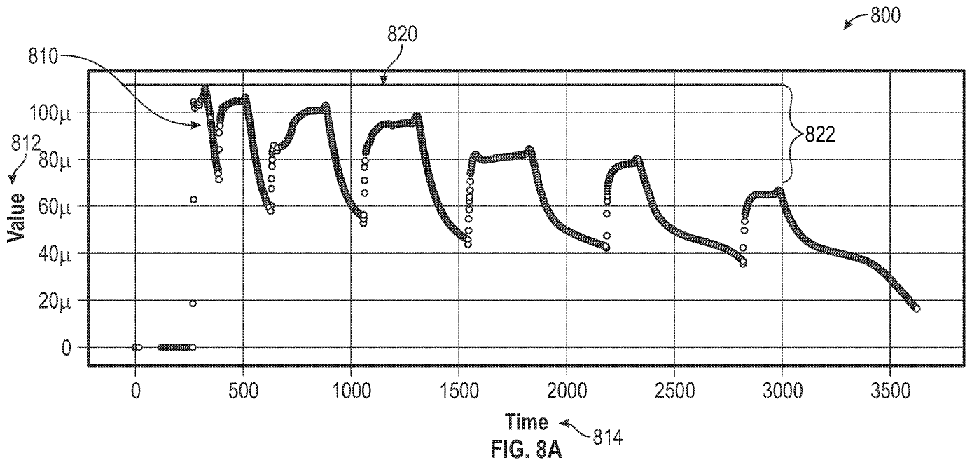

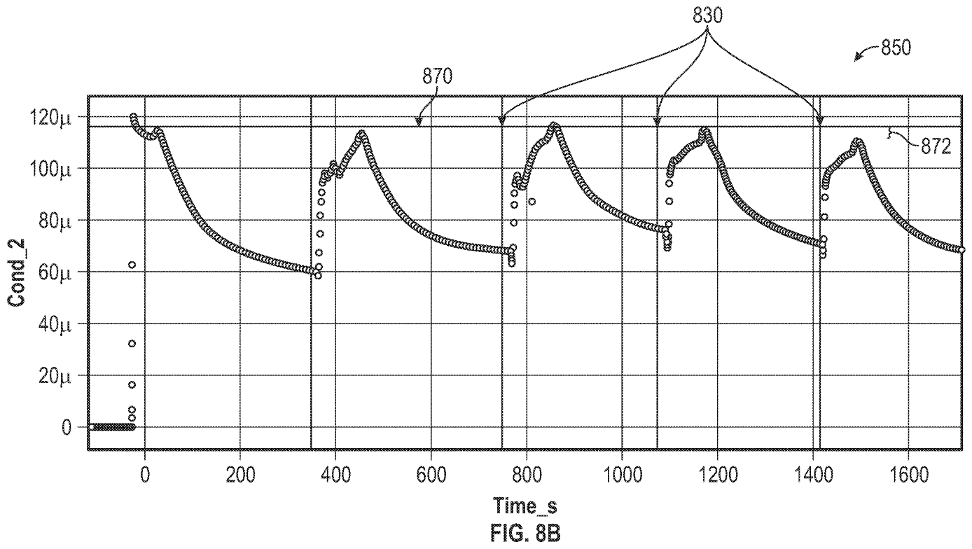

FIGS. 8A-8B illustrate conductivity measurements over time in accordance with embodiments herein. FIG. 8A illustrates a graph 800 of conductivity measurements 810, with conductivity measurements 812 on the Y-axis and time 814 on the X-axis. To illustrate the problem with inaccurate purge timing, the data in FIG. 8A was generated using periodically increasing purge timers-1, 2, 3, 4, 6, 8, and 10 minutes in sequence. The Y-axis 812 can be used as a proxy for “goodness” of a material, e.g. “dispensability.” The value does not recover after each dispensing operation, as illustrated by an initial peak 820 as compared to the last peak. Differential 822 is indicative of a decrease in quality of the material being dispensed. Similar behavior can be seen in previous figures described herein, e.g. FIG. 7B.

It would be preferred to keep only fresh material in a dispenser at all times. However, this results in considerable waste as material is flowing when dispensing should be “stopped.” To keep material fresh enough, it is possible to calculate a purge time such that a purge of the system will return material to freshness. It is noted that, for longer dispensing operations, purging alone will not be enough to maintain freshness.

Comparing FIG. 8B, which illustrates data obtained using the method described in FIG. 9, to FIG. 8A, it is shown that calculating a purge time provides “fresh” material longer. Purges 830 are indicated. A differential 872 between a first peak 870, and a latest peak is significantly smaller.

It is noted that the time between purges may not be the same for every “stopped” period in a dispensing operation. In some embodiments, therefore, the purge timer calculation is done in real-time based on received data.

FIG. 9 illustrates a method for automatically triggering a purge in accordance with embodiments herein. Method 900 may benefit from the techniques discussed above with respect to FIG. 5, for example, for detecting a dispenser running status. Other techniques for detecting flow starts and stops may also be used.

At block 910, sensor signals are received. For example, in some embodiments herein a sensor is placed in direct contact with a material being dispensed, the sensor having multiple distinct electrode pairs configured to detect conductivity of the material as the material flows through, or past, the electrodes. The received sensor signals are stored. However, while method 900 may be used with the sensor of FIGS. 2A-2B in some embodiments, it is expressly contemplated that other sensors or sensing systems are possible. Similarly, while conductivity is described herein as a parameter of interest, it is expressly contemplated that method 900 may, in some embodiments, rely on other parameters such as impedance or dielectric constant.

At block 920, a stop in material flow is detected. The stop in material flow may be detected using methods described in FIGS. 5-6, in some embodiments herein. However, it is expressly contemplated that other detection methods may be used. For example, a controller of a dispensing system may generate a “flow stopped” signal and provide it to a purge timer calculator. The controller may generate the “flow stopped” signal based on an indication of a pump speed changing, based on an input from an operator to stop a fluid flow, or another suitable indication.

At block 930, a first purge characteristic signal is detected by a purge signal analysis system. The characteristic signal differs based on different products. For example, some products will see two sharp decreases in conductivity, others may see different changes as the material approaches a curing point-of-no-return. The signal analysis system may be part of, or controlled by, a dispenser control system.

At block 940, a second purge characteristic signal is detected by the purge signal analysis system. The second purge characteristic may be similar to the first, e.g. a second sharp decrease, or different, e.g. a slow decrease, slow increase, fast increase, etc.

Depending on the curing profile for a given material, different purge characteristics may be detected in the received electrical parameters. Some potential purge characteristics may include: a change in slope; a detected inflection point in the system, a change from linear to non-linear behavior, a change from non-linear to linear behavior, a stable value—e.g. flat or nearly flat line, changing from increasing to decreasing, or change from increasing to decreasing.

The first and second detected purge characteristics may be the same, or different characteristics. For example, a first characteristic may be a change in slope and a second detected purge characteristic may be a stable, mostly flat line. Other combinations are expressly contemplated, from the list above, or from other suitable and detectable changes in received electrical parameter values.

At block 950, a purge is indicated based on the detected purge characteristics. In some embodiments, the purge is triggered automatically based on the detected purge characteristics. In some embodiments, an indication is provided on a user interface indicating that a purge is recommended. After a purge has completed, the method may return back to block 930 and the purge signal analysis system may continue monitoring received signals for a first purge characteristic signal.

At block 960, a fluid flow start is detected. In some embodiments, a purge signal analysis system is only activated when a flow stop is detected, and stopped when a fluid flow is detected. In some embodiments, the purge signal analysis system is actively analyzing received sensor signals.

Blocks 920 and 930 of method 900 describe processes of detecting purge characteristics in a received electrical signal. It is expressly contemplated, however, that for some materials only a single purge characteristic is needed to determine when a purge is recommended. For some materials, more than two characteristics may need to be detected.

Detecting purge characteristics, in some embodiments, is done in real-time based on a live data stream of conductivity values delivered from one or more electrical signal sensors. The electrical signal sensor may provide an impedance signal, a conductivity signal, or a dielectric constant. A single sensor may receive multiple signals—e.g. like the sensor described in FIGS. 2A-2B.

A buffer is created to store an appropriate number of data points along with timestamps constituting a time series dataframe. Each datapoint includes electrical signals with associated timestamps.

Using the buffer, a material flow stop is detected. Detecting a stop in material flow can be done, for example, using the method described in FIGS. 5-6, or another suitable method. Once it is known that the fluid flow is stopped, the data stream is read into a buffer to look for features characteristic of a purge. As each feature is found, it is logged and the search for the next feature is started. When the terminal feature is found, the method sends a signal to either the user interface to direct them to purge immediately or to the dispenser directly to initiate a purge via the equipment controller. Multiple buffers may be required depending on complexity.

FIGS. 8A and 8B illustrate conductivity data for DP 810 acrylic adhesive. Two buffers were used for generating a purge timer. The first buffer included an array of time x and an array of conductivity y, which could be a vector Y of multiple conductivities or other data recorded by the sensor, such as temperature, dielectric constant, etc. The second buffer contained the gradient of the first buffer, e.g. the first parameter of the first-order polynomial fit of the first buffer. In the case of DP 810, there are two primary features that indicate a need to purge: the first is the transition from rapidly decreasing conductivity to slowly decreasing conductivity and the second is a shift back to rapidly decreasing. Both signals must be determined as they appear in the buffered data stream.

The first buffer is constructed as illustrated in Equation 7:

$$buffer\_ 1 = [ \begin{matrix}[ {x}_{t - 10} , {x}_{t} ] , \\ [ {y}_{t - 10} , {y}_{t} ]\end{matrix} ] \qquad Equation 7$$

Where x is the timestamp and y the conductivity at time=t.

The second buffer is constructed as illustrated in Equation 8:

$$buffer\_ 2 = [ {P}_{t - 10} , {P}_{t} ] \qquad Equation 8$$

Where P is the first parameter of the first-order polyfit of the first buffer, and described by Equation 9:

$$P = polyfit ( buffer\_ 1 [ 0 ] , buffer\_ 1 [ 1 ] , 1 ) [ 0 ] \qquad Equation 9$$

With the buffers in place, the first signal can be expressed as Equation 10:

$${\sum }_{i = 1}^{n / 2} buffer\_ {2}_{i} < {\sum }_{i = \frac{n}{2} + 1}^{n} buffer\_ {2}_{i} \qquad Equation 10$$

The second signal can then be expressed as the reverse of the first signal, as expressed in Equation 11:

$${\sum }_{i = 1}^{n / 2} buffer\_ {2}_{i} > {\sum }_{i = \frac{n}{2} + 1}^{n} buffer\_ {2}_{i} \qquad Equation 11$$

After the second signal is detected, an indication is given to the user to purge material.

The characteristics of a purge vary by material chemistry.

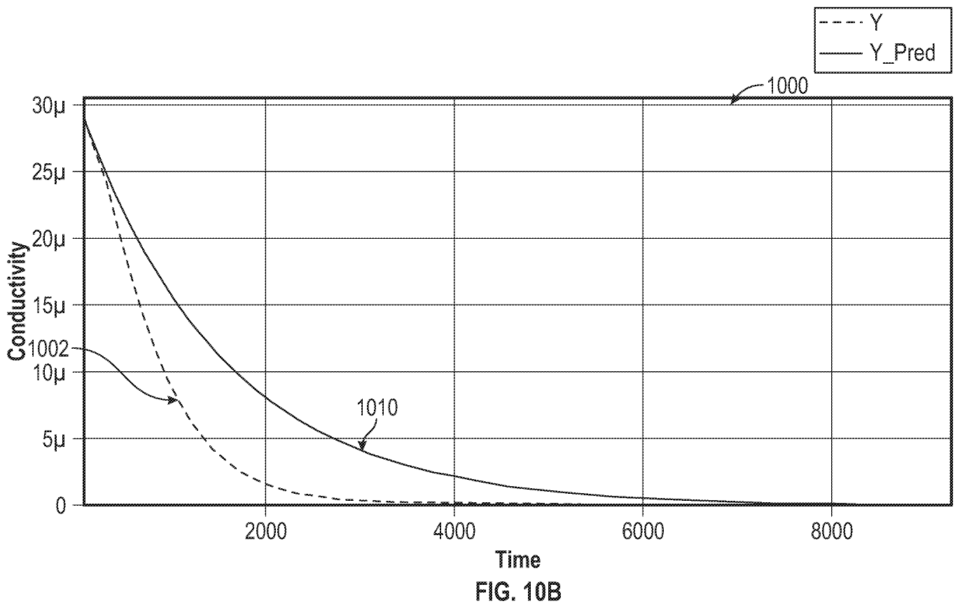

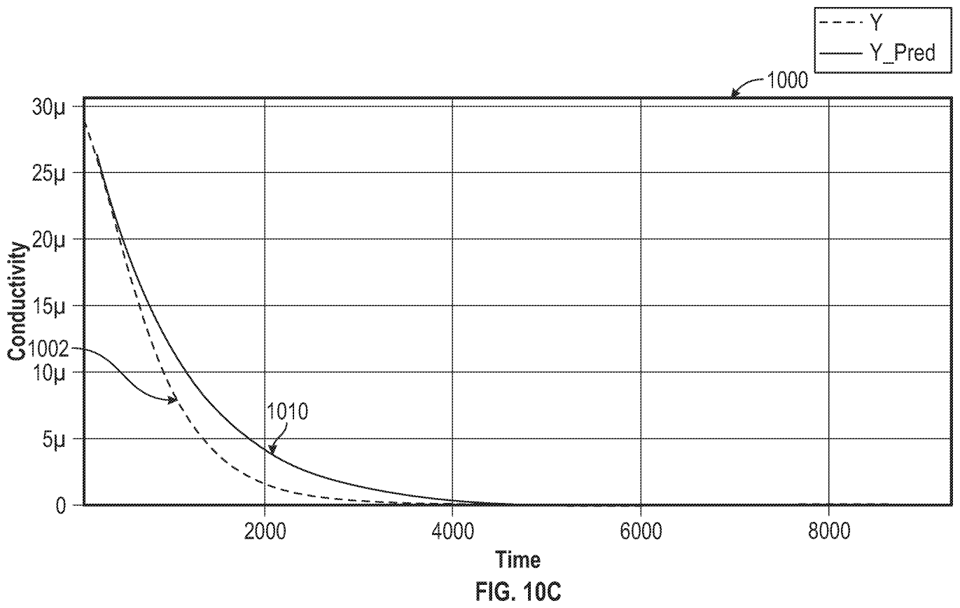

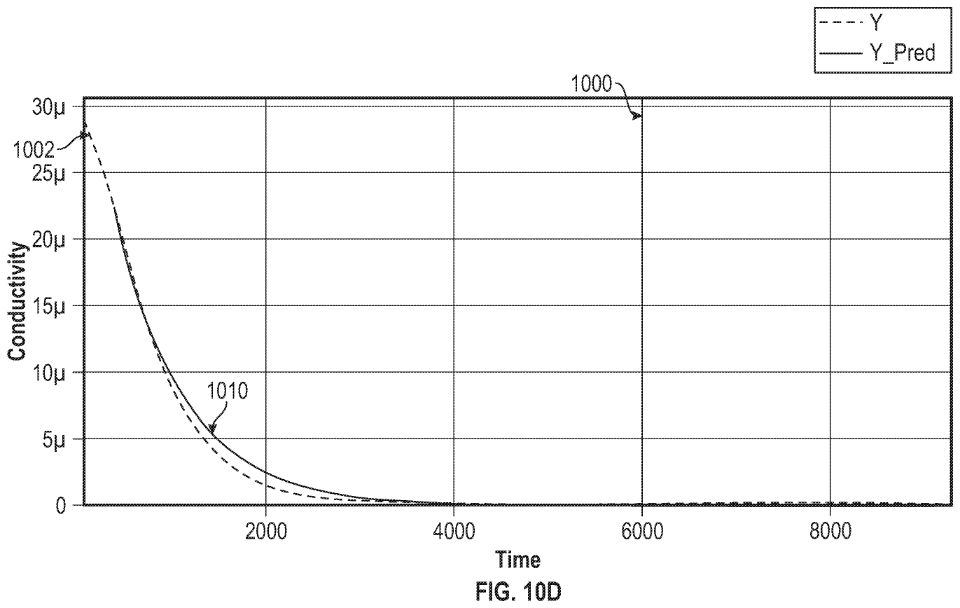

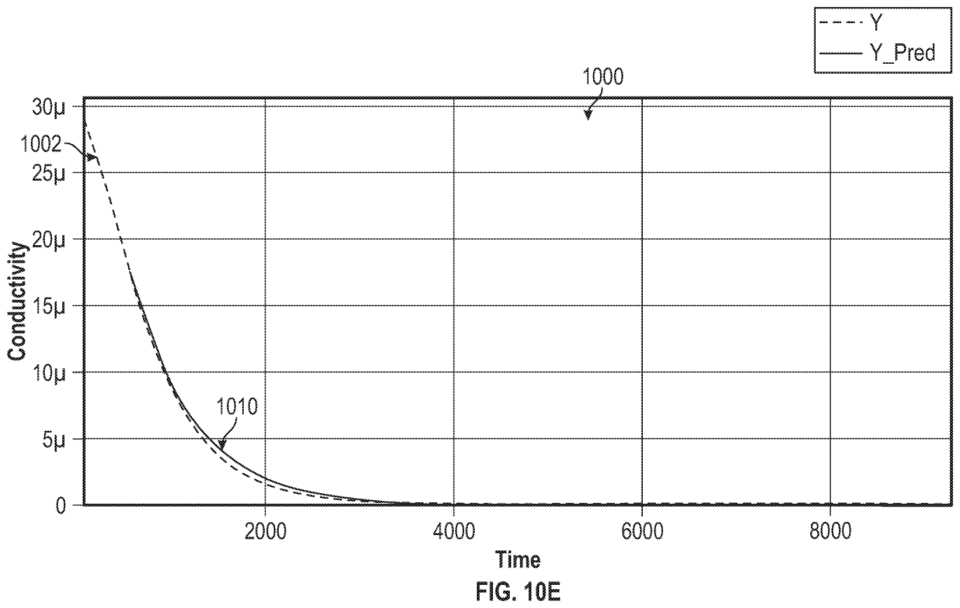

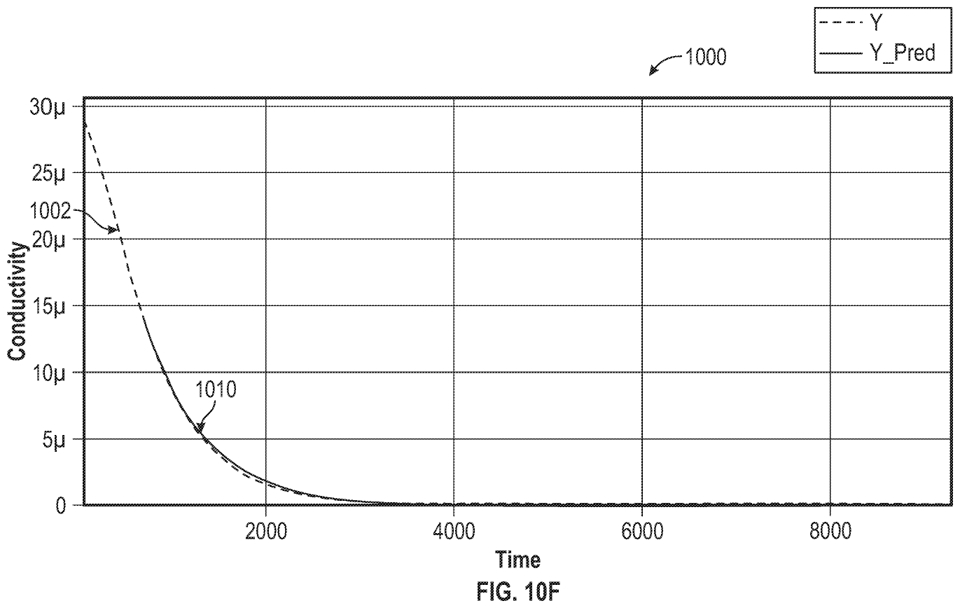

FIGS. 10A-10E illustrate a purge time calculation in accordance with embodiments herein. For some materials, detecting a first purge characteristic is detecting a long-term prediction of stability. Determining when the calculation of a purge timer can be done requires that a long-term prediction be stable. As discussed herein, a buffer stores a number of time stamped datapoints forming a time series dataframe. To determine stability, the datapoints are fit to a known equation that describes the conductivity response to curing over time for a given material, which may be different for each material based on material chemistry.

With each buffer state, the curve fit is updated, and once a sufficient fit is achieved, a purge calculation can be done. The purge calculation involves passing a threshold value representative of a degree of cure that is still purgeable.

FIG. 10A illustrates a graph 1000 of a conductivity curve 1002 for DP 420 epoxy, available from 3MR Company, located in Maplewood, Minnesota. One difficulty is that the beginning portion of the data is noisy immediately following a flow stoppage. A buffer with a specified size limits the amount of recent datapoints. FIG. 10B illustrates a graph of a fit 1010 generated shortly after a detected stop.

Systems and methods herein conduct analysis of data in real-time. With real-time analysis, it is not easily known that the fit is poor and that a resulting purge calculation will not be accurate. A fit is re-calculated as new data points are received, illustrated in the progression of the graphs of FIGS. 10C-10E.

The quality of fit is quantified and compared with each buffer state. Once the fit is stable, the purge calculation can be done. The initial conductivity, Go, was recorded at the beginning of the dispense and some threshold, C, was applied to get Equation 12.

$${σ}_{purge} = C {σ}_{0} \qquad Equation 12$$

The time when σ_{purge} will be reached is calculated with the above fit. A purge timer can then be shown to a human user and/or be kept in the background software. When the purge time is reached, the human user is notified to start a purge and/or a controller is sent a signal to initiate a purge.

Systems and methods are described herein that detect starts and stops in material flowing through a sensor, determines the time to purge at the time the purge is needed. Systems and methods herein can be used with a static purge timer to give a human user advance warning that a purge request is coming soon, in some embodiments. In some embodiments, systems and methods herein are coupled to, or integrated into, a dispenser controller directly.

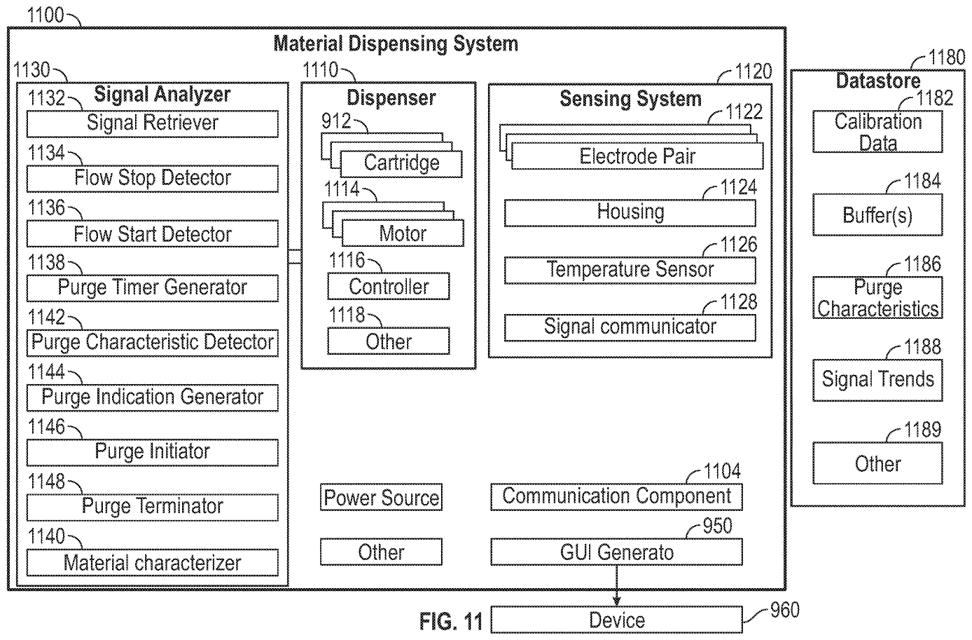

FIG. 11 illustrates a dispensing system in accordance with embodiments herein. System 1100 may include a dispenser 1110 with one or more cartridges 1112 containing a material to be dispensed. A cartridge 1112 may dispense material at a rate based in part on a speed of a corresponding motor 1114. A dispenser controller 1116 may provide a control signal to motor(s) 1114 to drive material flow from each cartridge 1112 by increasing or decreasing a speed of corresponding motors 1114. Dispenser 1110 may have other features 1118, such as a heating or cooling element if material is dispensed at an elevated temperature or if heat needs to be provided or removed from an exothermic or endothermic reaction of reactive components.

Dispensing system 1100 may also include a sensing system 1120, with one or more electronic signal sensors 1122. Systems and methods herein are discussed in the context of conductivity measurements. However, it is expressly contemplated that other electronic signals may be suitable, and used interchangeably, such as impedance or dielectric constant. In some embodiments, electrode pairs 1122 are received by a housing 1124 coupled to dispenser 1110. Sensing system 1120 may also include a temperature sensor. In embodiments where a sensing system 1120 is remote from a signal analyzer 1130, a signal communicator 1128 may provide the sensed electronic signals to analyzer 1130.

Material dispensing system may also include a power source 1102. A communication component 1104 may be used to facilitate communication between dispenser 1110, sensing system 1120, signal analyzer 1130 and datastore 1180.

A signal analyzer 1130 may receive sensor signals from sensing system 1120, using signal receiver 1132. Signals may be received as a conductivity signal or a dielectric constant signal, but may also be received as an impedance signal. Based on received sensor signals, analyzer 1130 may trigger a number of calculations and/or predictions. For example, a number of material characterizations may be calculated by a material characterizer 1140, such as a mixing ratio of components being dispensed, an age of material, an amount of curing, or entrained air.

Signal analyzer 1130 is illustrated as having a number of components 1132-1148, however it is expressly contemplated that the functionality described with respect to said components may be done using multiple processors, either located together, separately, or in any suitable configuration.

Signal retriever 1132 retrieves sensor signals from sensing system 1120. Sensor signals may be retrieved in real time or substantially real-time (e.g. within a short enough delay that calculation of a purge timer or detection of a purge signal is completed before a purge is recommended).

Based on signals from signal retriever 1132, a flow stop detector 1134 can detect that flow has stopped in a dispenser. Based on the detected stop in flow, a purge timer may be generated, by purge timer generator 1144. The generated purge timer may be a purge threshold retrieved based on an identity of a material. Purge indication retriever 1144 may generate a purge timer indication—e.g. a countdown timer displayed on a user interface or a message that a purge is needed. GUI generator 950 may generate a graphical user interface for display on device 960 that includes the purge indication. A flow start detector 1136 may detect that a material has started flowing through a dispenser again. Based on the detection of fluid flow, a purge timer may be stopped.

In some embodiments, when a stop in flow is detected, a purge characteristic detector 1138, based on sensor signals retrieved after the stop in flow, monitor the sensor signals until a purge characteristic is detected. Monitoring the sensor signals may include generating a buffer of recent datapoints (electrical signal(s) and timestamps) and analyzing the buffer. Analyzing the buffer may include generating a fit. A purge characteristic may include the generated fit being stable. However, a purge characteristic may also be detected from the received sensor signals, such as a change in electrical signal behavior—e.g. a rapid drop in a parameter value, a rapid increase in a parameter value, a leveling off of the parameter value, or another behavior indicative of curing. Some potential purge characteristics may include: a change in slope; a detected inflection point in the system, a change from linear to non-linear behavior, a change from non-linear to linear behavior, a stable value—e.g. flat or nearly flat line, changing from increasing to decreasing, or change from increasing to decreasing. Additionally, a change in the variability between sensor channels could be detected, or a change in the measured difference between the channels. The change may be a relative change or a change over a threshold value.

In some embodiments, signal analyzer 1130 may communicate with controller 1116. For example, based on a detected need to purge dispenser 1110, a purge initiator 1146 may send a signal to controller 1116 to start a purge of dispenser 1110. Purging dispenser 1110 will cause a change in received sensor signals, as a Part A or a Part B of a mixture will have a different characteristic electrical signal than the mixture itself. Based on a detection that a purge is complete, a purge terminator 1148 may send a signal to controller to 1116 to stop a purge.

Purge characteristic detector 1138 may continue analyzing sensor signals until flow start detector 1136 detects that material has started flowing through dispenser again 1110. It is expressly contemplated that flow stop detector 1134, flow start detector 1136, and purge characteristic detector 1138 may operate continuously, regardless of a running state of the dispenser 1110. However, it is also contemplated that any of detectors 1134, 1136 and 1138 may not monitor a live feed of sensor signals when not required. For example, purge characteristic detector 1138 may not be actuated until after flow stop detector 1134 detects a stop in flow.

A datastore 1180 may be accessed by controller 1116 or signal retriever 1132, for example. Datastore 1180 may include calibration data 1182 for a dispenser 1110, for example. Datastore 1180 may also include buffer(s) 1184 described herein. Datastore 1180 may include purge characteristics 1186 for a number of different materials. Purge characteristics 1186 may be used by purge characteristic detector 1138. Signal trends 1188 may also be stored, for example for later analysis. Datastore 1180 may also include other information 1189.

Datastore 1180 may be local to controller 1116 or analyzer 1130, or may be accessible through a wireless or cloud-based network. Similarly, while controller 1116 is illustrated in FIG. 10 as local to dispensing system 1110, it is expressly contemplated that controller 930 may be remote from material dispensing system and may receive signals, and send commands, using a wireless or cloud-based network.

A GUI generator 1150 may generate a graphical user interface for display on a display component 1160 based on some or all of the information gathered or generated by signal analyzer 1130. For example, conductivity sensor data may be presented. A calculated mixing ratio may also be presented, as well as dispensing parameters, including target mixing ratio, motor speed, pressure, temperature, etc.

Dispensing system 1100 is described as having the functionality of receiving and sending communicable information to and from other devices. This may be done through an application program interface, for example, such that controller 1116 can receive and communicate with pump controllers, line pressure sensors, movement controllers for portions of dispensing system, temperature sensors, heating elements, datastores having information for any of the materials being dispensed or the mixture being generated, etc.

Similarly, as described herein, a display on a device 1160 may display a GUI created by generator 1150 that is updated periodically with information that analyzer 930 has access to, such as any sensor data received, any analysis results generated by any of detectors 1134-1138 or generators 1142-1148, any information retrieved from datastore 1180, etc. Information may be passively updated, or provided with an alert or notification as it is updated, for example current status information may be presented and an alert (visual, audio, or haptic) may be provided if the mixing ratio is drifting toward an unacceptable range. Additionally, or alternatively, notifications may be provided when a device command is generated, or when operator intervention is needed.

Systems and methods are described herein that assist in coordinating purging of a material dispenser. It is expressly contemplated that, in some embodiments, systems and methods herein are a closed system, such that when a purge is needed, a signal is sent and a purge triggered automatically as needed. However, in some embodiments a manual instruction to purge a system is required.

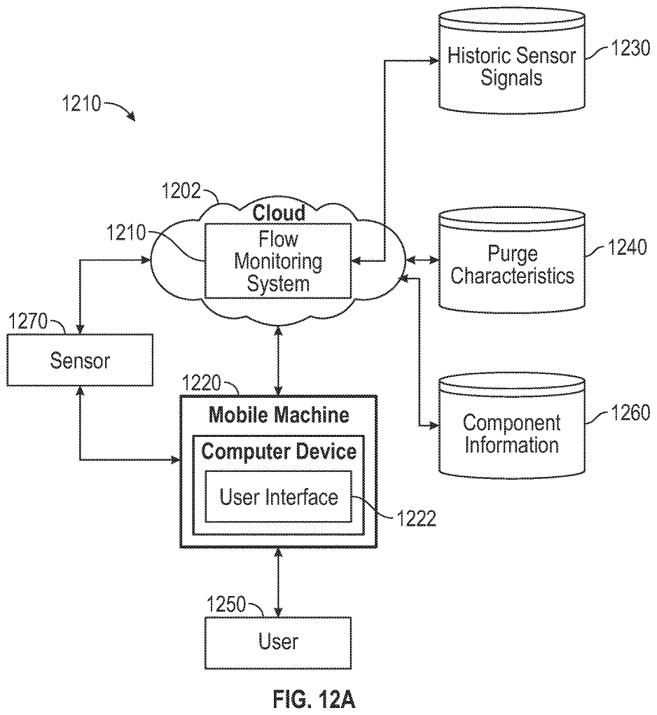

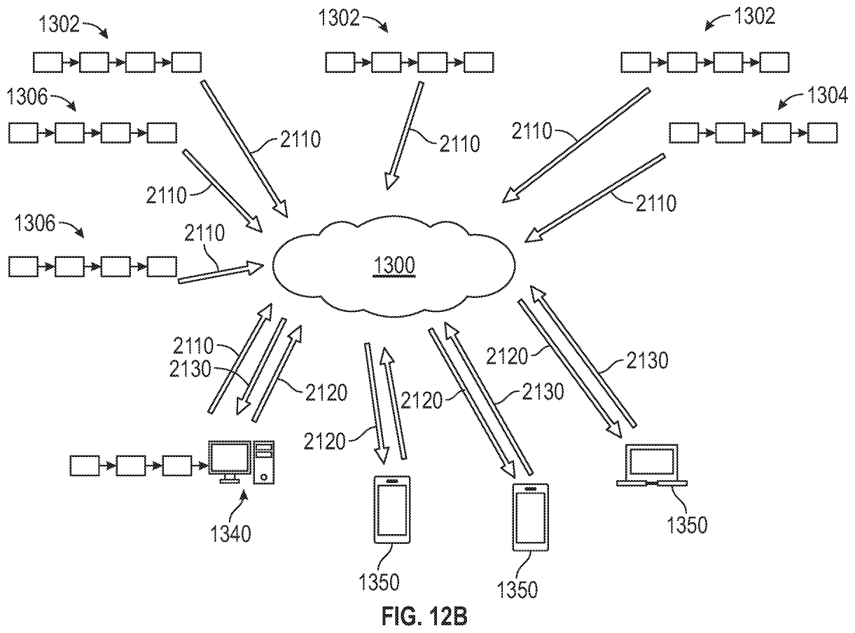

FIG. 12A illustrates a concentration profile simulation system architecture. Architecture 1200 illustrates one embodiment of an implementation of a flow monitoring system 1210. As an example, architecture 1200 can provide computation, software, data access, and storage services that do not require end-user knowledge of the physical location or configuration of the system that delivers the services. In various embodiments, remote servers can deliver the services over a wide area network, such as the internet, using appropriate protocols. For instance, remote servers can deliver applications over a wide area network and they can be accessed through a web browser or any other computing component. Software or components shown or described in FIGS. 1-11 as well as the corresponding data, can be stored on servers at a remote location. The computing resources in a remote server environment can be consolidated at a remote data center location or they can be dispersed. Remote server infrastructures can deliver services through shared data centers, even though they appear as a single point of access for the user. Thus, the components and functions described herein can be provided from a remote server at a remote location using a remote server architecture. Alternatively, they can be provided by a conventional server, installed on client devices directly, or in other ways.

In the example shown in FIG. 12, some items are similar to those shown in earlier figures. FIG. 12 specifically shows that a conductivity sensing system 1210 can be located at a remote server location 1202. Therefore, computing device 1220 accesses those systems through remote server location 1202. User 1250 can use computing device 1220 to access user interfaces 1222 as well. For example, a user 1250 may be a user wanting to check a fit of their respiratory protection device while sitting in a parking lot, and interacting with an application on the user interface 1222 of their smartphone 1220, or laptop 1220, or other computing device 1220.

FIG. 12A shows that it is also contemplated that some elements of systems described herein are disposed at remote server location 1202 while others are not. By way of example, data stores 1230, 1240 and/or 1260 can be disposed at a location separate from location 1202 and accessed through the remote server at location 1202. Regardless of where they are located, they can be accessed directly by computing device 1220, through a network (either a wide area network or a local area network), hosted at a remote site by a service, provided as a service, or accessed by a connection service that resides in a remote location. Also, the data can be stored in substantially any location and intermittently accessed by, or forwarded to, interested parties. For instance, physical carriers can be used instead of, or in addition to, electromagnetic wave carriers. This may allow a user 1250 to interact with system 1210 through their computing device 1260, to initiate a seal check process.

It will also be noted that the elements of systems described herein, or portions of them, can be disposed on a wide variety of different devices. Some of those devices include servers, desktop computers, laptop computers, imbedded computer, industrial controllers, tablet computers, or other mobile devices, such as palm top computers, cell phones, smart phones, multimedia players, personal digital assistants, etc.

FIG. 12B illustrates a signal analysis system 1300 that communicates with a number of devices using a cloud-based network.—As illustrated in FIG. 7C signal analysis system 1300 may communicate with a local analysis system 1340, such as that described with respect to FIG. 12B. Signal analysis system 1300 may receive a number of sensor signal data 1310 from a number of dispensing operations, such as a pilot line 1304, any of an operational line 1302, and/or a laboratory set up 1306. Sensor signals 1300 may be digital signals, analog signals, conductivity measurement signals, pressure signals, or other signal information.—For example, a low reservoir detected signal, a valve switch indication, or any other detectable indication from any of systems 1302-1306.

Signal analysis system 1300 may conduct analysis on receive sensor signal information 1300, for example using any suitable analysis tool such as lookup table, comparison thresholds, and/or machine learning algorithms to detect parameter trend information that may indicate a problem, or an action that needs to be taken, such as purging, adjusting mix ratio, etc.

Signal analysis of 1300 may provide output indicia 1320 a number of suitable devices 1350. Signal analysis system 1300 may provide output information 1320 continuously, or in response to a request 1330 information. Or request 1330 may be a one-time request for current status information, or a request to receive continuous updates going forward.

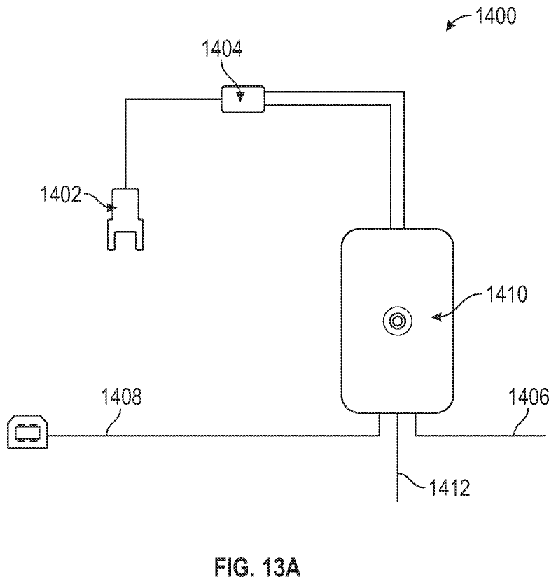

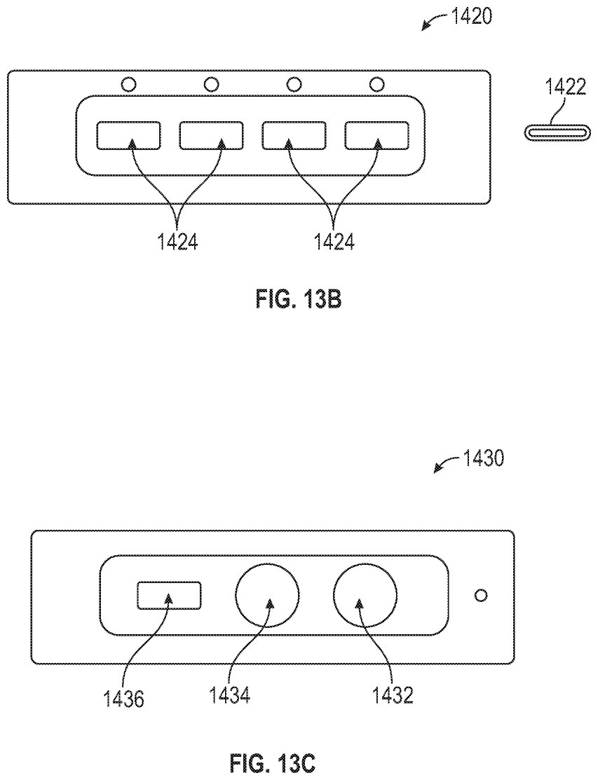

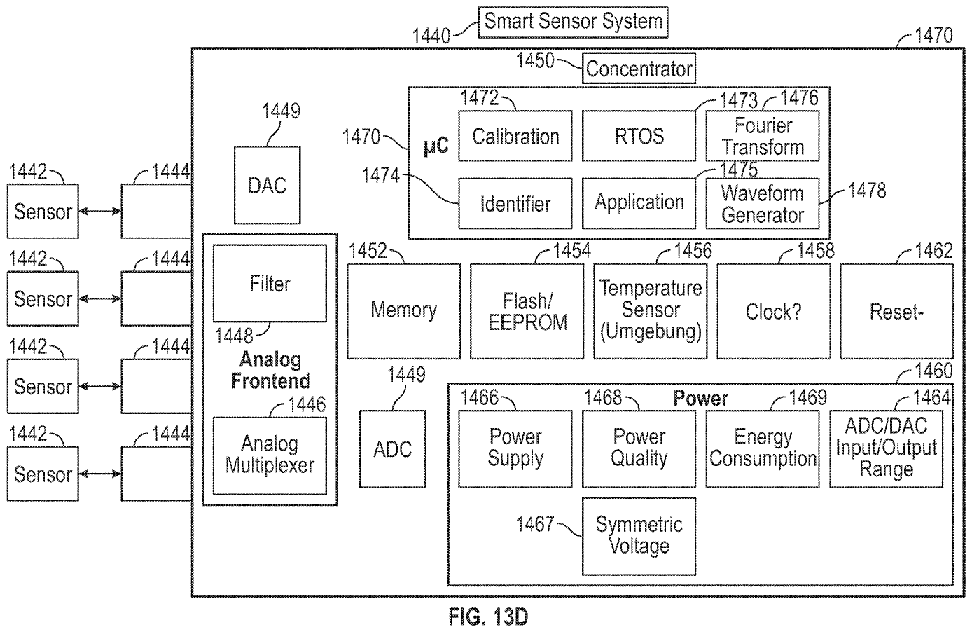

FIG. 13A-13D illustrate a sensing system in according with embodiments herein. Current sensing setups include components from different manufacturers, and data preparation and processing is done using a separate computing device. However, it is desired to have a robust and compact system that processes data quickly with limited downtime or booting time, such that quality concerns with a material are detected quickly.

In some embodiments herein a sensor contains signal preparation and processing within a single housing, e.g. a “smart” sensor. Such smart sensors contain a processing component—e.g. a microprocessor, a microcontroller, a digital signal processor or other processing circuitry. In some embodiments, a sensor also includes one or more standardized interfaces for interfacing with other systems—e.g. fieldbus systems, sensor networks, input/output links, etc. In some embodiments herein, sensor signal processing is completed without an external computer. Sensing systems herein provide decentralization, increased reliability, reduced cost, increased flexibility and simplification.

In some embodiments, a sensor system herein includes a concentrator which integrates electronic parts in a single housing. In some embodiments, all electronic components are on one PCB. In some embodiments, an analog frontend with signal conversion (e.g. AD-Converters, DA-Converters or both) are connected to a microcontroller that performs signal converting, processing and provide an output signal. Sensing systems herein may also incorporate operational circuitry, including power-supply, I/O protection circuitry, signal conditioning, reset management and/or debugging circuitry and interfaces. In some embodiments herein, the concentrator includes user-interface components such as LED signaling, UART, USB, wireless interfaces (e.g. Bluetooth®, WiFi, Zigbee®, cellular network), dot-matrix or alphanumeric display, industrial bus systems and/or tactile interface components such as push-buttons, switches, touchscreens, etc.

Systems herein may include user accessible data—e.g. a signal value, a pass/fail (e.g. “yes” or “no,” “go” or “stop,” etc.). Systems herein may provide a quality or quantity indication. Systems herein may provide a data stream with time and/or frequency-dependent data for storage and/or further processing. Systems herein may include algorithms and/or calibrations needed for data manipulation.

FIG. 13A illustrates a schematic of a sensing system in accordance with embodiments herein. Sensing system 1400 may be used with sensor described in embodiments herein, for example, or with another suitable sensor. A sensor signal reader 1402 connects to a sensor, for example an edge connector of a PCB-board that includes one or more electrode pairs. In some embodiments, a trans-impedance amplifier is present to convert current measurements to voltage. A concentrator 1410 receives sensor signals, processes said sensor signals, and provides an output. An output may be provided using an I/O device 1406 and/or another wired or wireless communication protocol 1408. A power source 1412 may provide power to concentrator 1410. While a wired power source 1412 is illustrated, it is possible that power may be provided wirelessly, or concentrator 1410 may be integrated into a material dispensing system from which it draws power.

FIG. 13B illustrates one example interface 1420 of a concentrator, that may receive sensor signals using one or more sensor signal receiving ports 1424. Other data or inputs may be received through another receiver 1422, in some embodiments.

FIG. 13C illustrates another interface 1430, which may receive a coupling to an input/output device. Power may be provided, for example using port 1434. Data may be communicated from a concentrator using a computer link 1436.

FIG. 13D illustrates a component diagram of a sensing system 1440 in accordance with embodiments herein. One or more sensors 1442 provide sensor signals, received by one or more receivers 1444 coupled to, or included within, a housing 1470. In some embodiments, system 1440 includes an analog front-end which may include a filter 1448 and/or an analog multiplexor 1446. A converter, e.g. a DA- or DC-converter 1449 may be present. Concentrator 1450 may include non-volatile memory 1452, flash memory 1454, or another suitable information storage. A temperature sensor 1456 may be incorporated into concentrator 1450, or receive a temperature signal from a temperature sensor. Concentrator 1450 may include a clock 1458. Concentrator 1462 may also include reset functionality 1462.

A sensor analyzer 1470 may include calibration data and/or functionality 1472. A real-time operating system 1473 may manage functionality. Sensor analyzer 1470 my include Fourier transformer 1476. Sensor analyzer 1470 may include a waveform generator 1476. Sensor analyzer may include other applications 1475 that provide other functionality, such as detecting of material characteristics like mix ratio, material age, curing progress, etc. Sensor analyzer 1470 may also include an identifier 1474 that identifies a type of sensor.

Concentrator 1450 may include a power management system 1460 that includes, or accesses, a power supply 1466. A power quality 1468 may be monitored. Energy consumption 1469 may be tracked. Conversion input and output ranges 1464 may be stored. A symmetric voltage 1467 may be used.

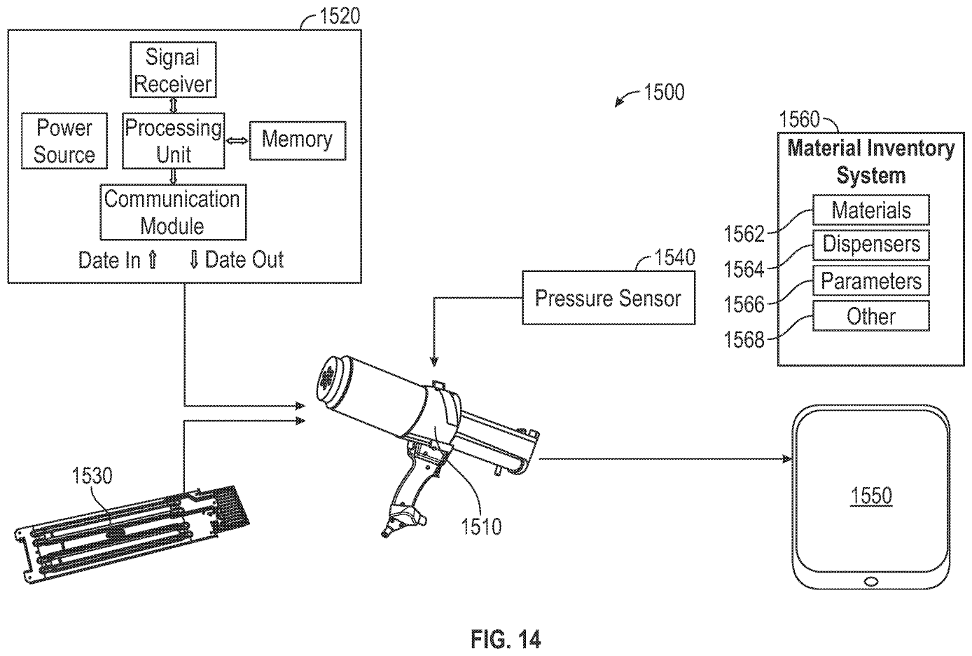

FIG. 14 illustrates a dispensing system in accordance with embodiments herein. Many dispensing operations are done with a portable, handheld system. Errors in dispensing or adhesive failure can result if material quality or machine settings are not correct. For example, an incorrect mix ratio or an incorrect pressure setting may result in an unacceptable product. It is desired to have a handheld dispensing system that can provide real-time sensing and feedback to a user. Described in FIG. 14 is one example of a system that can receive and process sensor signals without a separate computing device. Described herein are many embodiments of sensors that may be used with a dispenser. Described herein are systems for measuring pressure in a dispensing system. System 1500 includes a dispenser 1510. Dispenser 1510 is illustrated as an adhesive dispenser 1510, however other dispensers may also benefit from systems described herein. Dispenser 1510 includes an in-line sensor 1530 that senses electrical properties of a material being dispensed. A pressure sensor 1540 is incorporated into dispenser 1510 and monitors the pressure within the dispenser.

Dispenser 1510 also includes a signal processing system 1520. A signal receiver receives a sensed parameter signal from sensor 1530. A processing unit, which may include any suitable processor or processing circuitry, processes the sensed signal. A memory may store calibration data, historic signals, etc. A display 1550 may present processed information to a user, the information received from signal processing system 1520, for example using a communication module. Display 1550 may be integrated into dispenser 1510, or another display visible to a dispenser operator, such as a mobile computer, a worksite display, etc. However, while a display 1550 is illustrated as conveying processed information to an operator, it is expressly contemplated that output from signal processing system 1520 can be presented as audio or haptic feedback in some embodiments herein.

Based on sensed signals, signal processing system 1520 may also actuate a change in dispensing parameters. For example, a mix ratio may be sensed that as drifted away from a specified mix ratio. Signal processing system 1520 may, based on the sensed mix ratio drift, adjust a mix ratio by changing a pump speed for one component. Signal processing system 1520 may control pump speed directly, or indirectly, such that an instruction to change the pump speed is sent to a pump controller. Signal processing system 1520 may also communicate the mix ratio drift, e.g. through display 1550. In some embodiments, signal processing system 1520 may only communicate a detected material issue—e.g. mix ratio, aging, curing, pressure, etc.—and an operator may need to take steps to address the issue manually. However, it is expressly contemplated that, in some embodiments, dispenser parameters are adjusted automatically, in real-time, based on signals from sensors 1530, 1540.

In some embodiments, dispensing system 1500 includes a material inventory system 1560. Material inventory system 1560 may store physical materials 1562 and dispensers 1564 (e.g. different static mixer types for placement in dispensing system 1510) available for operator use. However, it is expressly contemplated that, in some embodiments, material inventory system 1560 stores only information about materials 1562 and dispensers 1564.

Materials 1562 may include information relevant to a dispensing operation that utilize them. For example, a dispensing cartridge may include an RFID tag, NFC tag, or other wirelessly accessible data storage. Information may also be transferred using a printed code-such as a bar code or QR code. In some embodiments, a printed RFID label is applied to dispensing cartridges.

When a cartridge of a material 1562 comes within a data transfer range (RFID range, NFC range, etc.) dispensing information can be retrieved by dispensing system 1510, or from material inventory system 1560. Dispensing information may include dispensing parameters 1566, such as an operating pressure for one or both components, and/or a preferred 1568 for use with material 1562. Other information may also be provided.

Based on the received information, system 1510 may display operating guidance on a display, e.g. 1550, for an operator. For example, in some embodiments, a dispenser receives expected process parameters from material information system 1560 based on an identification of material 1562 from an NFC tag, RFID tag, or other information storage system on a material to be dispensed.

Using sensors such that those described herein, or other suitable sensors, it may then also be possible for dispensing system 1510 to receive sensed electrical parameter values, from which ongoing process conditions may be determined-mix ratio, material age, curing, etc. Based on sensed process values, guidance may be provided or action automatically taken by system 1510 to correct an inconsistency.

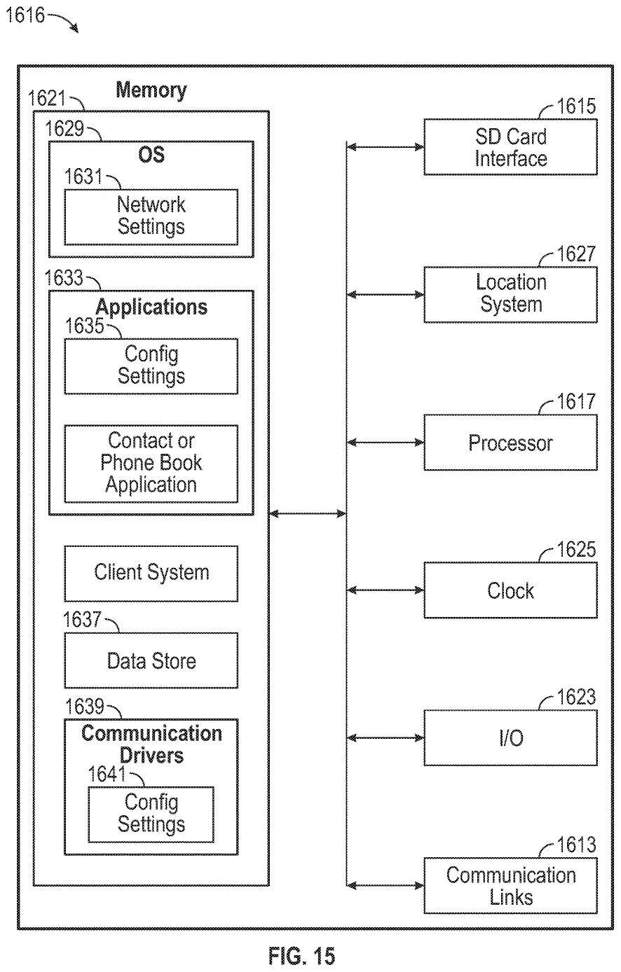

FIGS. 15-17 illustrate example devices that can be used in the embodiments shown in previous Figures. FIG. 15 illustrates an example mobile device that can be used in the embodiments shown in previous Figures. FIG. 15 is a simplified block diagram of one illustrative example of a handheld or mobile computing device that can be used as either a worker's device or a supervisor/safety officer device, for example, in which the present system (or parts of it) can be deployed. For instance, a mobile device can be deployed in the operator compartment of computing device for use in generating, processing, or displaying the data.

FIG. 15 provides a general block diagram of the components of a mobile cellular device 1616 that can run some components shown and described herein. Mobile cellular device 1616 interacts with them or runs some and interacts with some. In the device 1616, a communications link 1613 is provided that allows the handheld device to communicate with other computing devices and under some embodiments provides a channel for receiving information automatically, such as by scanning. Examples of communications link 1613 include allowing communication though one or more communication protocols, such as wireless services used to provide cellular access to a network, as well as protocols that provide local wireless connections to networks.

In other examples, applications can be received on a removable Secure Digital (SD) card that is connected to an interface 1615. Interface 1615 and communication links 1613 communicate with a processor 1614 (which can also embody a processor) along a bus that is also connected to memory 1621 and input/output (I/O) components 1623, as well as clock 1625 and location system 1627.

I/O components 1623, in one embodiment, are provided to facilitate input and output operations and the device 1616 can include input components such as buttons, touch sensors, optical sensors, microphones, touch screens, proximity sensors, accelerometers, orientation sensors and output components such as a display device, a speaker, and or a printer port. Other I/O components 1623 can be used as well.

Clock 1625 illustratively comprises a real time clock component that outputs a time and ate. It can also provide timing functions for processor 1617.

Illustratively, location system 1627 includes a component that outputs a current geographical location of device 1616. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 1621 stores operating system 1629, network settings 1631, applications 1633, application configuration settings 1635, data store 1637, communication drivers 1639, and communication configuration settings 1641. Memory 1621 can include all types of tangible volatile and non-volatile computer-readable memory devices. It can also include computer storage media (described below). Memory 1621 stores computer readable instructions that, when executed by processor 1617, cause the processor to perform computer-implemented steps or functions according to the instructions. Processor 1617 can be activated by other components to facilitate their functionality as well. It is expressly contemplated that, while a physical memory store 1621 is illustrated as part of a device, that cloud computing options, where some data and/or processing is done using a remote service, are available.

FIG. 15 shows that the device can also be a smart phone 1771. Smart phone 1771 has a touch sensitive display 1773 that displays icons or tiles or other user input mechanisms 1775. Mechanisms 1775 can be used by a user to run applications, make calls, perform data transfer operations, etc. In general, smart phone 1771 is built on a mobile operating system and offers more advanced computing capability and connectivity than a feature phone. Note that other forms of the devices are possible.

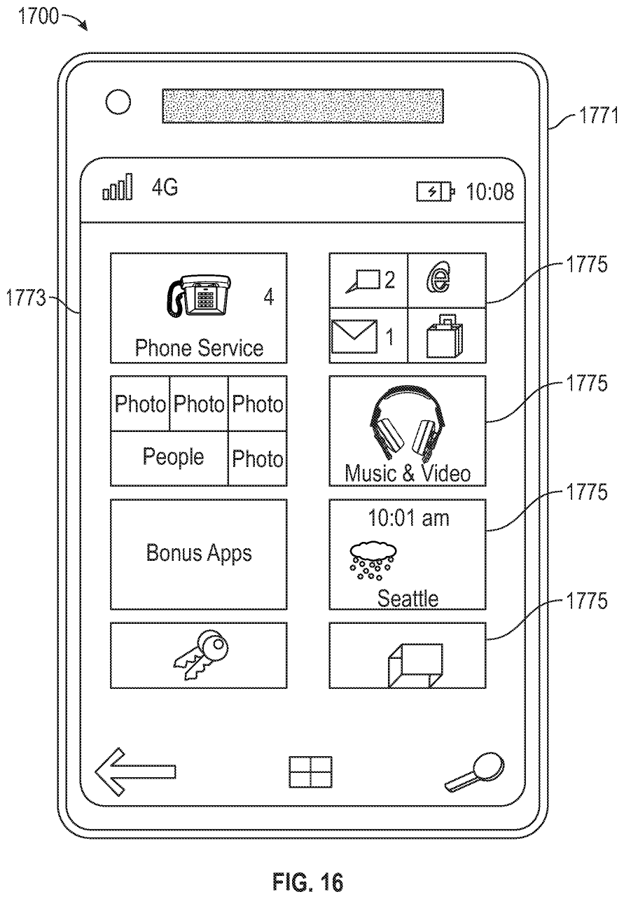

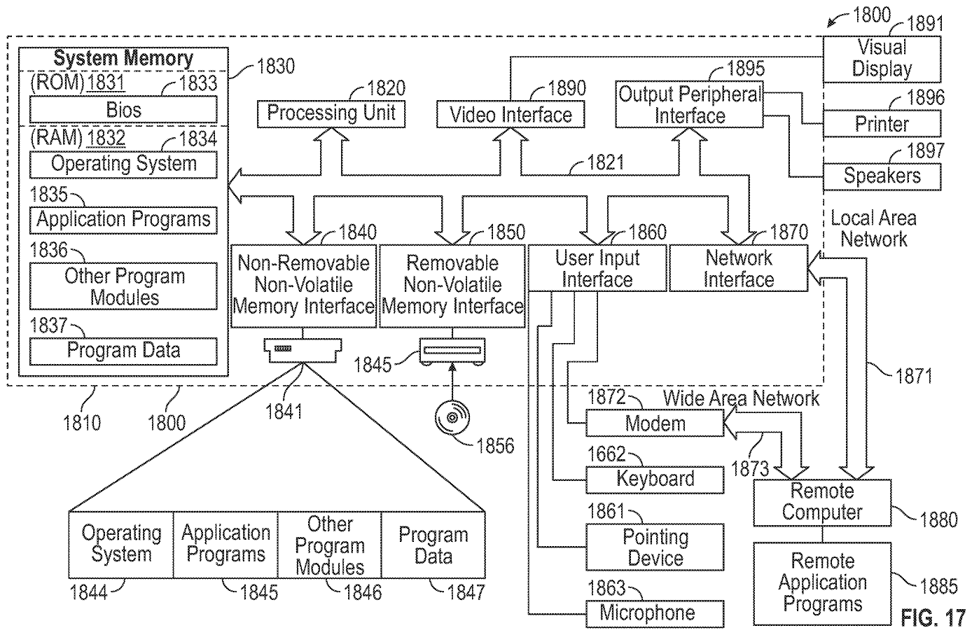

However, while FIG. 15 illustrates an embodiment where a device 1500 is a smart phone 1771, it is expressly contemplated that a display may be presented on another computing device. FIG. 16 is one example of a computing environment in which elements of systems and methods described herein, or parts of them (for example), can be deployed. With reference to FIG. 16, an example system for implementing some embodiments includes a general-purpose computing device in the form of a computer 1810. Components of computer 1810 may include, but are not limited to, a processing unit 1820 (which can comprise a processor), a system memory 1830, and a system bus 1821 that couples various system components including the system memory to the processing unit 1820. The system bus 1821 may be any of several types of bus structures including a memory bus or memory controller, a peripheral bus, and a local bus using any of a variety of bus architectures. Memory and programs described with respect to systems and methods described herein can be deployed in corresponding portions of FIG. 17.

Computer 1810 typically includes a variety of computer readable media. Computer readable media can be any available media that can be accessed by computer 1810 and includes both volatile/nonvolatile media and removable/non-removable media. By way of example, and not limitation, computer readable media may comprise computer storage media and communication media. Computer storage media is different from, and does not include, a modulated data signal or carrier wave. It includes hardware storage media including both volatile/nonvolatile and removable/non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 1810. Communication media may embody computer readable instructions, data structures, program modules or other data in a transport mechanism and includes any information delivery media. The term “modulated data signal” means a signal that has one or more of its characteristics set or changed in such a manner as to encode information in the signal.

The system memory 1830 includes computer storage media in the form of volatile and/or nonvolatile memory such as read only memory (ROM) 1831 and random-access memory (RAM) 1832. A basic input/output system 1833 (BIOS) containing the basic routines that help to transfer information between elements within computer 1810, such as during start-up, is typically stored in ROM 1831. RAM 1832 typically contains data and/or program modules that are immediately accessible to and/or presently being operated on by processing unit 1820. By way of example, and not limitation, FIG. 15 illustrates operating system 1834, application programs 1835, other program modules 1836, and program data 1837.

The computer 1810 may also include other removable/non-removable and volatile/nonvolatile computer storage media. By way of example only, FIG. 17 illustrates a hard disk drive 1841 that reads from or writes to non-removable, nonvolatile magnetic media, nonvolatile magnetic disk 1852, an optical disk drive 1855, and nonvolatile optical disk 1856. The hard disk drive 1841 is typically connected to the system bus 1821 through a non-removable memory interface such as interface 1840, and optical disk drive 1855 are typically connected to the system bus 1821 by a removable memory interface, such as interface 1850.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (e.g., ASICs), Application-specific Standard Products (e.g., ASSPs), System-on-a-chip systems (SOCs), Complex Programmable Logic Devices (CPLDs), etc.

The drives and their associated computer storage media discussed above and illustrated in FIG. 17, provide storage of computer readable instructions, data structures, program modules and other data for the computer 1810. In FIG. 17, for example, hard disk drive 1841 is illustrated as storing operating system 1844, application programs 1845, other program modules 1846, and program data 1847. Note that these components can either be the same as or different from operating system 1834, application programs 1835, other program modules 1836, and program data 1837.

A user may enter commands and information into the computer 1810 through input devices such as a keyboard 1862, a microphone 1863, and a pointing device 1861, such as a mouse, trackball or touch pad. Other input devices (not shown) may include a joystick, game pad, satellite receiver, scanner, or the like. These and other input devices are often connected to the processing unit 1820 through a user input interface 1860 that is coupled to the system bus but may be connected by other interface and bus structures. A visual display 1891 or other type of display device is also connected to the system bus 1821 via an interface, such as a video interface 1890. In addition to the monitor, computers may also include other peripheral output devices such as speakers 1897 and printer 1896, which may be connected through an output peripheral interface 1895.

The computer 1810 is operated in a networked environment using logical connections, such as a Local Area Network (LAN) or Wide Area Network (WAN) to one or more remote computers, such as a remote computer 1880.

When used in a LAN networking environment, the computer 1810 is connected to the LAN 1871 through a network interface or adapter 1870. When used in a WAN networking environment, the computer 1810 typically includes a modem 1872 or other means for establishing communications over the WAN 1873, such as the Internet. In a networked environment, program modules may be stored in a remote memory storage device. FIG. 17 illustrates, for example, that remote application programs 1885 can reside on remote computer 1880.

In the present detailed description of the preferred embodiments, reference is made to the accompanying drawings, which illustrate specific embodiments in which the invention may be practiced. The illustrated embodiments are not intended to be exhaustive of all embodiments according to the invention. It is to be understood that other embodiments may be utilized and structural or logical changes may be made without departing from the scope of the present invention. The following detailed description, therefore, is not to be taken in a limiting sense, and the scope of the present invention is defined by the appended claims.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

Spatially related terms, including but not limited to, “proximate,” “distal,” “lower,” “upper,” “beneath,” “below,” “above,” and “on top,” if used herein, are utilized for ease of description to describe spatial relationships of an element(s) to another. Such spatially related terms encompass different orientations of the device in use or operation in addition to the particular orientations depicted in the figures and described herein. For example, if an object depicted in the figures is turned over or flipped over, portions previously described as below or beneath other elements would then be above or on top of those other elements.

As used herein, when an element, component, or layer for example is described as forming a “coincident interface” with, or being “on,” “connected to,” “coupled with,” “stacked on” or “in contact with” another element, component, or layer, it can be directly on, directly connected to, directly coupled with, directly stacked on, in direct contact with, or intervening elements, components or layers may be on, connected, coupled or in contact with the particular element, component, or layer, for example. When an element, component, or layer for example is referred to as being “directly on,” “directly connected to,” “directly coupled with,” or “directly in contact with” another element, there are no intervening elements, components or layers for example. The techniques of this disclosure may be implemented in a wide variety of computer devices, such as servers, laptop computers, desktop computers, notebook computers, tablet computers, hand-held computers, smart phones, and the like. Any components, modules or units have been described to emphasize functional aspects and do not necessarily require realization by different hardware units. The techniques described herein may also be implemented in hardware, software, firmware, or any combination thereof. Any features described as modules, units or components may be implemented together in an integrated logic device or separately as discrete but interoperable logic devices. In some cases, various features may be implemented as an integrated circuit device, such as an integrated circuit chip or chipset. Additionally, although a number of distinct modules have been described throughout this description, many of which perform unique functions, all the functions of all of the modules may be combined into a single module, or even split into further additional modules. The modules described herein are only exemplary and have been described as such for better ease of understanding.

If implemented in software, the techniques may be realized at least in part by a computer-readable medium comprising instructions that, when executed in a processor, performs one or more of the methods described above. The computer-readable medium may comprise a tangible computer-readable storage medium and may form part of a computer program product, which may include packaging materials. The computer-readable storage medium may comprise random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The computer-readable storage medium may also comprise a non-volatile storage device, such as a hard-disk, magnetic tape, a compact disk (CD), digital versatile disk (DVD), Blu-ray disk, holographic data storage media, or other non-volatile storage device.

The term “processor,” as used herein may refer to any of the foregoing structure or any other one or more structures suitable for implementation of the techniques described herein. In addition, in some aspects, the functionality described herein may be provided within dedicated software modules or hardware modules configured for performing the techniques of this disclosure. Even if implemented in software, the techniques may use hardware such as a processor to execute the software, and a memory to store the software. In any such cases, the computers described herein may define a specific machine that is capable of executing the specific functions described herein. Also, the techniques could be fully implemented in one or more circuits or logic elements, which could also be considered a processor.

A dispensing system is presented that includes a channel through which a material to be dispensed flows. The dispensing system includes a sensor within the channel, in direct contact with the material. The sensor is configured to generate a sensor signal indicative of an electrical parameter of the material flow. The sensor also includes a flow state detector configured to, based on the sensed electrical parameter, detect a change in flow state of the material within the channel. The change in flow state includes a start of flow or a stop of flow. The system also includes a communication component configured to communicate the detected change in flow state.

The system may be implemented such that the detected change in flow state is a detected stop in material flow.

The system may be implemented such that the detected change in flow state is a detected material flow start.

The system may be implemented such that it includes a purge indication generator that, based on the detected stop, is configured to generate a purge indication.

The system may be implemented such that the the purge indication includes a purge timer selected based on a threshold cure time for the material.

The system may be implemented such that the detecting the change in flow state includes generating a buffer of a plurality of datapoints. Each of the plurality of datapoints includes a sensor signal value and a timestamp.

The system may be implemented such that the plurality of datapoints include recent datapoints.

The system may be implemented such that the buffer includes a set number of datapoints such that, as a newest datapoint is received, an oldest datapoint is removed from the buffer.

The system may be implemented such that a correlation coefficient is determined for the plurality of sensor signal values.

The system may be implemented such that the sensor is configured to generate a first sensor signal, from a first sensing element, and a second sensor signal, from a second sensing element. The correlation coefficient is a first correlation coefficient corresponding to a first plurality of sensor signal values associated with the first sensing element, and further including a second correlation coefficient corresponding to a second plurality of sensor values associated with the second sensing element, and further including the flow state detector generating a characteristic coefficient based on the first and second correlation coefficient.

The system may be implemented such that the flow detector generating a filtered set by applying a filter to the characteristic coefficient.

The system may be implemented such that the flow detector compares the filtered set to a threshold and, based on the comparison detects the stop in material flow.

The system may be implemented such that the threshold includes a parameter specific to the material.

The system may be implemented such that the detected change in flow state is a first change in flow state. The first change in flow state includes a detected stop of flow, and wherein a second change in flow state includes a detected start of flow. The system further includes a purge clock generator that, based on the detected stop of flow, generates a purge clock and, based on the detected start of flow, cancels the purge clock.

The system may be implemented such that the purge indication generator is configured to, based on the sensed electrical parameters, generate a purge buffer including a plurality of purge datapoints, the plurality of purge datapoints each including a sensed electrical parameter and a timestamp.

The system may be implemented such that the purge indication generator, based on the purge buffer, is configured to detect a purge signal.

The system may be implemented such that the based on the purge signal, the purge indication generator triggers a purge of the dispensing system, wherein the purge includes emptying the channel.

The system may be implemented such that, based on the purge signal, the purge indication generator generates the purge indication.

The system may be implemented such that the purge signal is a first signal and the purge signal is also generated based on a detected second signal.

The system may be implemented such that the first signal includes a rapid change in the sensed electrical parameter, a slow change in the sensed electrical parameter, or a lack of change in the sensed parameter.

The system may be implemented such that the purge signal includes a detected stable fit.

The system may be implemented such that the purge signal generator is further configured to: fitting, for the buffer, a first curve from the plurality of datapoints, receive a new sensed signal at a time, generate a new buffer by adding a new datapoint to the buffer including the new sensed signal and the time, fitting for the new buffer, a second curves. The system is also configured to compare the first and second curve and, based on the comparison, detect the stable fit.

The system may be implemented such that the comparing includes determining a variance between the first and second curves and comparing the variance to a threshold variance.

The system may be implemented such that the generated purge indication includes a purge timer.

The system may be implemented such that the generated purge indication is communicated to a user interface generator for a device with a display. The user interface generator generates a user interface to include the generated purge indication.

The system may be implemented such that the generated purge indication includes an indication that a purge is needed.

The system may be implemented such that the generated purge indication includes a purge signal, and wherein the communication component is configured to communicate the purge signal to a controller of the dispensing system.

The system may be implemented such that the detected change in flow state is a detected purge start.

The system may be implemented such that the detected change in flow state is a detected purge complete.

The system may be implemented such that the flow state detector is configured to detect the change in flow state in real-time.

The system may be implemented such that the communication component is configured to communicate the sensed electrical parameter to a user interface generator for a device with a display in real-time.

The system may be implemented such that the communication component is configured to communicate the detected change in flow state to the user interface generator in real-time.

The system may be implemented such that the electrical parameter includes a conductivity, an impedance or a relative permittivity.

The system may be implemented such that the sensor includes an electrode pair.

The system may be implemented such that the sensor includes a plurality of electrode pairs.

The system may be implemented such that the sensor includes a printed circuit board.

The system may be implemented such that the sensor includes a temperature sensor.

A method of purging a dispenser is presented, the method comprising receiving a sensor signal from a sensor housed within the dispenser, the sensor signal being indicative of an electrical parameter of a material, the material being flowable through the dispenser. The method also includes detecting, using a flow state detector, a stop in flow of the material through the dispenser, based on the sensed electrical parameter. The method also includes generating, using a purge indication generator, a purge indication based on the detected stop in flow. The method also includes communicating the generated purge indication, using a communication component.

The method may be implemented such that it includes initiating a purge of the dispenser. The method may be implemented such that it includes communicating the generated purge indication includes sending a purge instruction to a controller of the dispenser.

The method may be implemented such that the purge instruction is sent in response to a user confirmation.

The method may be implemented to include detecting, using the flow state detector, a purge start based on the sensed electrical parameter.

The method may be implemented to include detecting, using the flow state detector, a purge completion based on the sensed electrical parameter.

The method may be implemented such that the purge indication is a purge timer.

The method may be implemented such that detecting the stop includes the flow state detector generating a buffer of a plurality of datapoints. Each of the plurality of datapoints includes a sensor signal value and a timestamp.

The system may be implemented such that the plurality of datapoints include recent datapoints.

The system may be implemented such that the buffer includes a set number of datapoints such that, as a newest datapoint is received, the flow state detector removes an oldest datapoint from the buffer.

The system may be implemented such that the flow state detector determines a correlation coefficient for the plurality of sensor signal values.

The system may be implemented such that the sensor signal includes a first sensor signal, from a first sensing element, and a second sensor signal, from a second sensing element. The correlation coefficient is a first correlation coefficient corresponding to a first plurality of sensor signal values associated with the first sensing element, and further including a second correlation coefficient corresponding to a second plurality of sensor values associated with the second sensing element, and further including the flow state detector generating a characteristic coefficient based on the first and second correlation coefficient.

The system may be implemented such that the flow detector generating a filtered set by applying a filter to the characteristic coefficient.

The system may be implemented to include the flow detector comparing the filtered set to a threshold and, based on the comparison detects the stop in material flow.

The system may be implemented such that the threshold includes a parameter specific to the material.

The system may be implemented to include generating, using the flow detector, a purge buffer including a plurality of purge datapoints, the plurality of purge datapoints each including a sensed electrical parameter and a timestamp.

The system may be implemented such that the purge indication generator, based on the purge buffer, is configured to detect a purge signal.

The system may be implemented to include generating, based on the purge signal, a purge of the dispensing system, wherein the purge includes emptying the channel.

The system may be implemented such that, based on the purge signal, the purge indication generator generates the purge indication.

The system may be implemented such that the purge signal is a first signal and wherein the purge signal is also generated based on a detected second signal.

The system may be implemented such that the first signal includes a rapid change in the sensed electrical parameter, a slow change in the sensed electrical parameter, or a lack of change in the sensed parameter.

The system may be implemented such that the purge signal includes a detected stable fit.

The system may be implemented to include generating the purge indication includes: generating, for the buffer, a first curve from the plurality of datapoints, using the purge indication generator, receiving, from the sensor, a new sensed signal at a time, generating, using the purge indication generator, a new buffer by adding a new datapoint to the buffer including the new sensed signal and the time, generating, using the purge indication generator, a second curve for the new buffer, comparing, using the purge indication, the first and second curve, and based on the comparison, detect the stable fit.

The system may be implemented such that comparing includes determining a variance between the first and second curves and comparing the variance to a threshold variance.

The system may be implemented such that the generated purge indication includes a purge timer.

The system may be implemented to include communicating the generated purge indication includes a user interface generator for a device with a display generating a user interface that includes the generated purge indication.

The system may be implemented such that the generated purge indication includes an indication that a purge is needed.

The system may be implemented such that the steps of receiving, detecting, and generating occur in real-time.

The system may be implemented such that the communication component is configured to communicate the sensed electrical parameter to a user interface generator for a device with a display in real-time.

The system may be implemented such that the communication component is configured to communicate the detected change in flow state to the user interface generator in real-time.

The system may be implemented such that the electrical parameter includes a conductivity, an impedance, or a relative permittivity.

The system may be implemented such that the sensor includes an electrode pair.

The system may be implemented such that the sensor includes a plurality of electrode pairs.

The system may be implemented such that the sensor includes a printed circuit board.

The system may be implemented such that the sensor includes a temperature sensor.

A purge initiation system for a material dispenser is presented that includes a signal receiver configured to receive a sensor signal indicative of an electrical parameter for a material being dispensed by the material dispenser. The system also includes a flow state detector configured to detect a material flow stop for the material within the dispenser based on the sensed electrical parameter. The system also includes a purge signal generator configured to generate a purge indication based on the received electrical parameter. The system also includes a communication component configured to communicate the purge indication.

The system may be implemented such that the flow detector is configured to, based on the sensed electrical parameter, detect a material flow start after the detected material flow stop.

The system may be implemented such that the purge indication includes a purge timer. In response to the detected material flow start, the purge signal generator cancels the purge timer.

The system may be implemented such that the flow detector is configured to, based on the sensed electrical parameter, detect a purge start.

The system may be implemented such that the flow detector is configured to, based on the sensed electrical parameter, detect a purge completion.

The system may be implemented such that, based on the detected purge completion, the purge signal generator is configured to generate a second purge indication based on a new received electrical parameter, received after the detected purge completion.

The system may be implemented such that the purge indication includes a purge timer selected based on a threshold cure time for the material.

The system may be implemented such that the flow detector detects a material flow stop by generating a buffer of a plurality of datapoints. Each of the plurality of datapoints includes a sensor signal value and a timestamp.

The system may be implemented such that the plurality of datapoints include recent datapoints.

The system may be implemented such that the buffer includes a set number of datapoints such that, as a newest datapoint is received, an oldest datapoint is removed from the buffer.

The system may be implemented such that a correlation coefficient is determined for the plurality of sensor signal values.

The system may be implemented such that the sensor signal includes a first sensor signal, from a first sensing element, and a second sensor signal, from a second sensing element. The correlation coefficient is a first correlation coefficient corresponding to a first plurality of sensor signal values associated with the first sensing element, and further including a second correlation coefficient corresponding to a second plurality of sensor values associated with the second sensing element, and further including the flow state detector generating a characteristic coefficient based on the first and second correlation coefficient.

The system may be implemented such that the flow state detector generates a filtered set by applying a filter to the characteristic coefficient.

The system may be implemented such that the flow state detector compares the filtered set to a threshold and, based on the comparison detects the stop in material flow.

The system may be implemented such that the threshold includes a parameter specific to the material.

The system may be implemented such that the purge signal generator is configured to, based on the received sensor signal, generate a purge buffer including a plurality of purge datapoints, the plurality of purge datapoints each including a sensed electrical parameter and a timestamp.

The system may be implemented such that the purge indication generator, based on the purge buffer, is configured to detect a purge signal.

The system may be implemented such that, based on the purge signal, the purge indication generator triggers a purge of the dispensing system, wherein the purge includes emptying the channel.

The system may be implemented such that, based on the purge signal, the purge signal generator generates the purge indication.

The system may be implemented such that the purge signal is a first signal and wherein the purge signal is also generated based on a detected second signal.

The system may be implemented such that the first signal includes a rapid change in the sensed electrical parameter, a slow change in the sensed electrical parameter, or a lack of change in the sensed parameter.

The system may be implemented such that the purge signal includes a detected stable fit.

The system may be implemented such that the purge signal generator is further configured to generate, for the buffer, a first curve from the plurality of datapoints, receive a new sensed signal at a time, generate a new buffer by adding a new datapoint to the buffer including the new sensed signal and the time, generate, for the new buffer, a second curve, compare the first and second curve, and based on the comparison, detect the stable fit.

The system may be implemented such that comparing includes determining a variance between the first and second curves and comparing the variance to a threshold variance.

The system may be implemented such that the generated purge indication is communicated to a user interface generator for a device with a display. The user interface generator generates a user interface to include the generated purge indication.

The system may be implemented such that the generated purge indication includes a purge signal. The communication component is configured to communicate the purge signal to a controller of the dispensing system.

The system may be implemented such that the signal receives, the flow state detector detects, and the purge signal generator are configured to operate in real-time.

The system may be implemented such that the communication component is configured to communicate the sensed electrical parameter to a user interface generator for a device with a display in real-time.

The system may be implemented such that the communication component is configured to communicate the detected change in flow state to the user interface generator in real-time.

The system may be implemented such that the electrical parameter includes a conductivity, an impedance or a relative permittivity.

### EXAMPLES

These examples are merely for illustrative purposes and are not meant to be overly limiting on the scope of the appended claims. Notwithstanding that the numerical ranges and parameters setting forth the broad scope of the present disclosure are approximations, the numerical values set forth in the specific examples are reported as precisely as possible. Any numerical value, however, inherently contains certain errors necessarily resulting from the standard deviation found in their respective testing measurements. At the very least, and not as an attempt to limit the application of the doctrine of equivalents to the scope of the claims, each numerical parameter should at least be construed considering the number of reported significant digits and by applying ordinary rounding.

Unless otherwise noted, all chemicals used in the examples can be obtained from the noted suppliers. Adhesives used in example embodiments can include the adhesives described below.

### Example 1: Start/Stop Detection with Epoxy and Four Channel Sensor

The above method was used with 3M™ Scotch-Weld™ Epoxy Adhesive DP460 to detect when the adhesive was being dispensed (started) or not being dispensed (stopped). The adhesive was dispensed using two progressive cavity pumps with a static mixing nozzle joining the flows of both pumps. The described sensor was placed at the tip of the static mixer so that mixed adhesive flowed through the sensor. Electrical readings from four separate channels within the sensor were then collected while the pumps were cycled on and off at various time intervals. Data from the sensor was stored in a transient buffer and equations 1-5 were used to quantify the variability in and within the channels for each new set of datapoints entering the buffer. Equation 6 was then used to determine whether a stop was detected. A purge timer was set based on the published open time and was started after the system had been stopped for one minute. When equation 6 determined that adhesive was flowing again, the purge timer was stopped if it had been displayed.

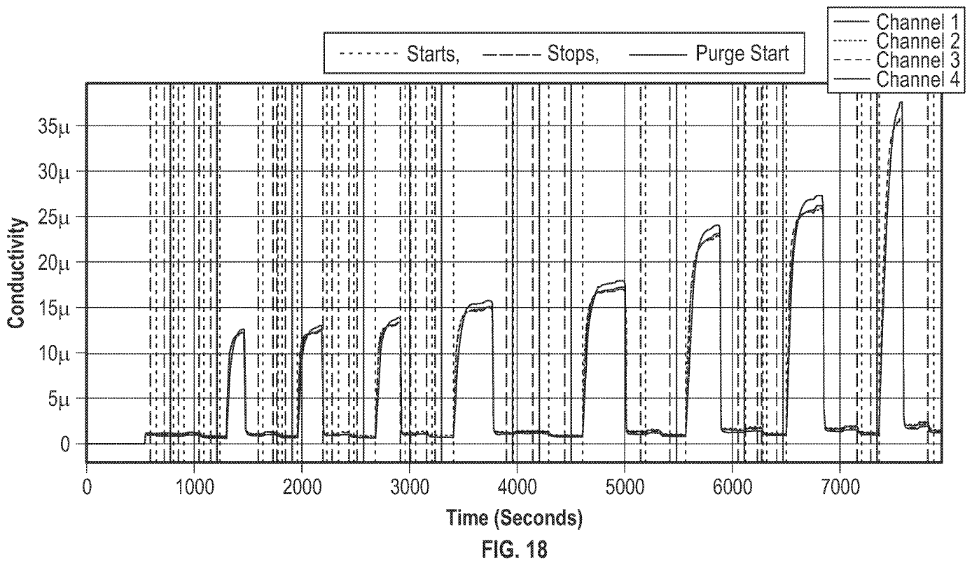

FIG. 18 shows the results accurately identifying the starts, the stops, and the purge timer starts. This was done over 7000 seconds and at various mix ratios and flow rates.

### Example 2: Start/Stop Detection with Epoxy and One Channel Sensor

Dispensing data similar to Example 1 was obtained using a one-channel sensor. This data was also using 3M™ Scotch-Weld™ Epoxy Adhesive DP460 but was obtained in a manufacturing setting instead of in a lab setting. The same analysis was completed with one channel buffer and this also was able to accurately identify the starts, stops, and suggested purge timer starts.

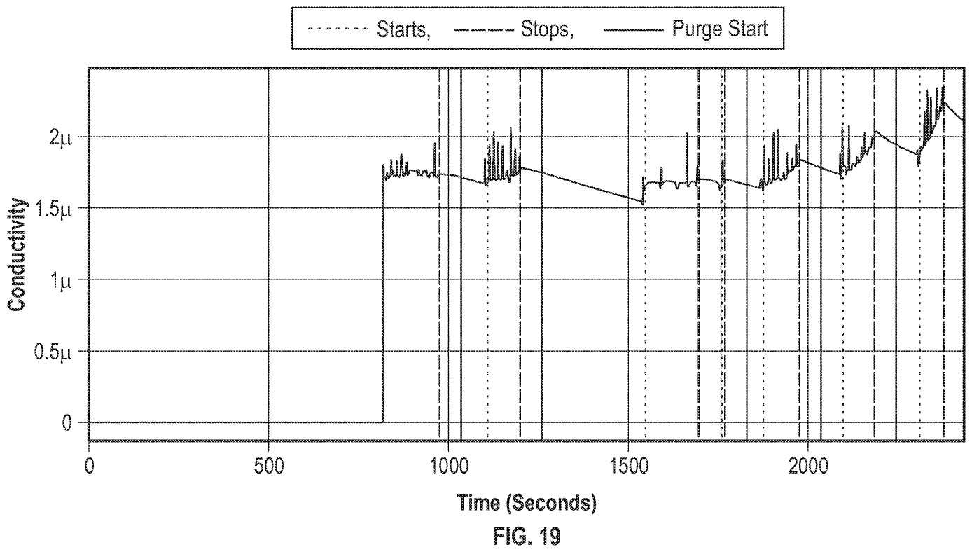

FIG. 19 shows the results accurately identifying the starts, the stops, and the purge timer starts. This was done over 1500 seconds with various dispensing times and rest times.

### Example 3: Start/Stop Detection with Urethane

Dispensing data similar to Example 1 was obtained using 3M™ Scotch-Weld™ Multi-Material Composite Urethane Adhesive DP6310NS. FIG [placeholder] shows the results accurately identifying the starts (green lines), the stops (red lines), and the purge timer starts (black lines). This was done over 500 seconds.

### Example 5: Start/Stop Detection with Acrylic and Extended Stoppage

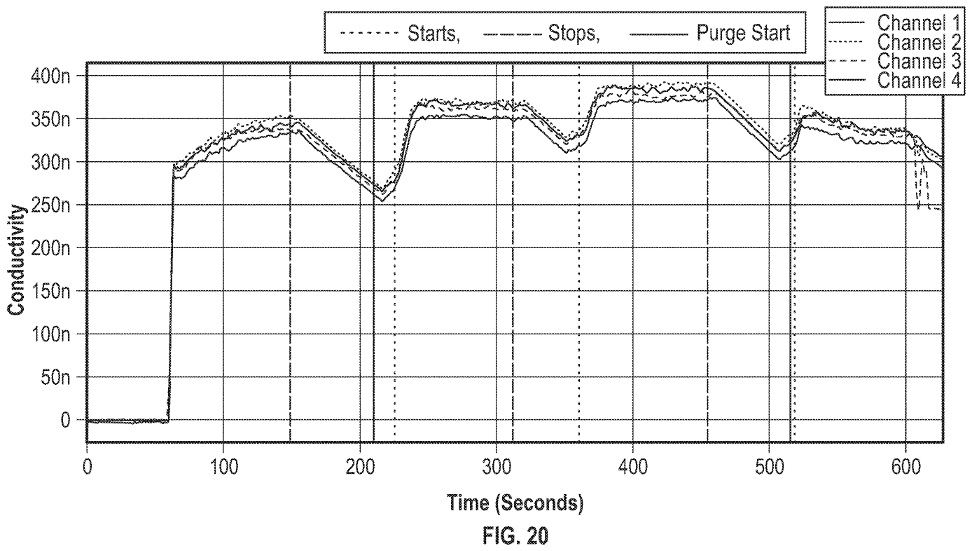

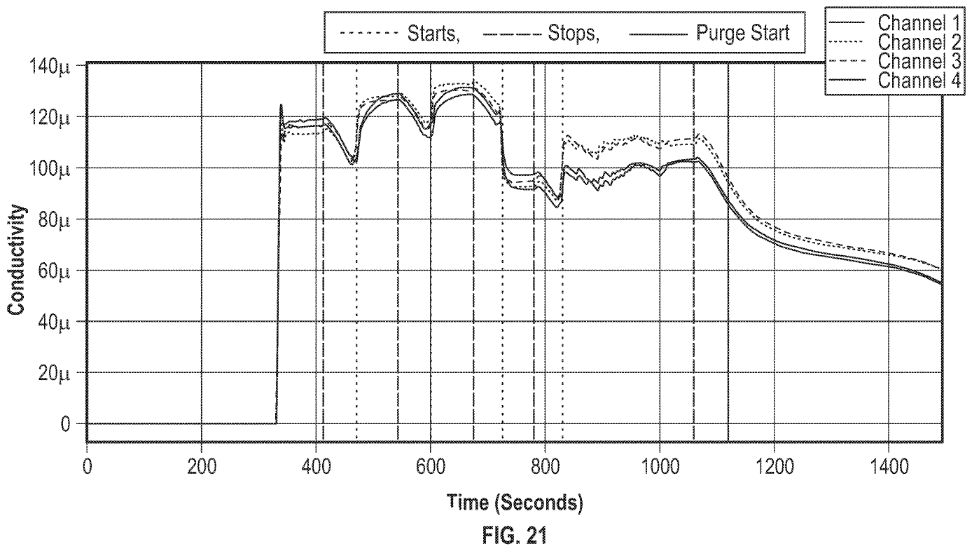

Dispensing data similar to Example 1 was obtained using 3M™ Scotch-Weld™ Low Odor Acrylic Adhesive DP810. FIG. 20 shows the results accurately identifying the starts (green lines), the stops (red lines), and the purge timer starts (black lines). This was done over 1000 seconds and incorporated a longer stop at the end of the dataset. The longer stop resulted in the adhesive curing in the sensor. The results continued to accurately indicate stopped flow with this condition.

### Example 6: Start/Stop Detection with Acrylic and Various Conditions

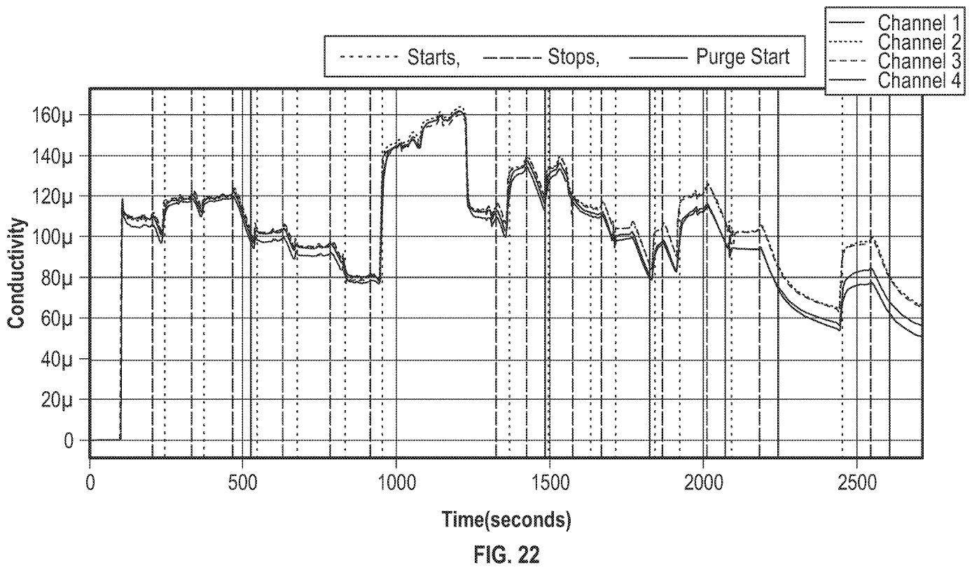

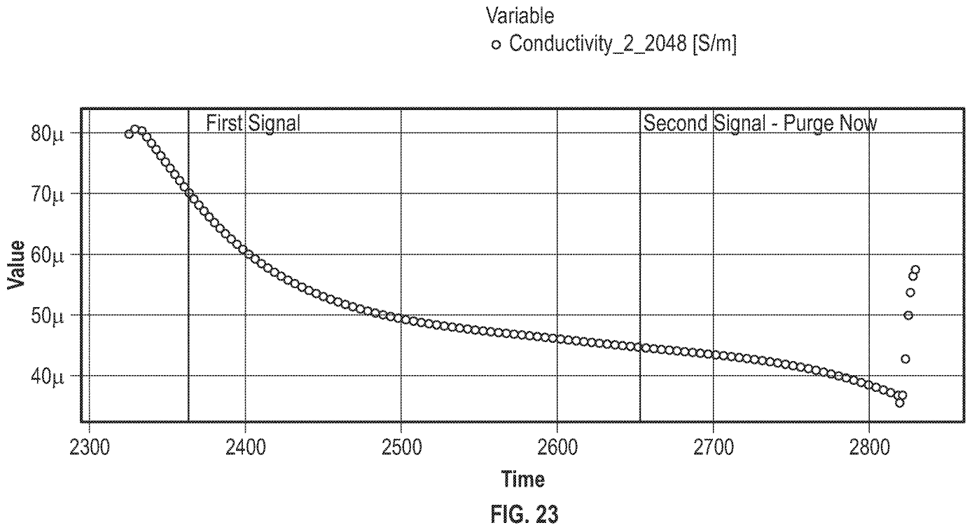

Dispensing data similar to Example 1 was obtained using 3M™ Scotch-Weld™ Low Odor Acrylic Adhesive DP810. FIG. 22 shows the results accurately identifying the starts, the stops, and the purge timer starts. This was done over 2500 seconds and incorporated a range of conditions such as different flow rates, different mix ratios, and different stop/start intervals. This method continued to identify the running and non-running conditions accurately.

### Example 7: Real-time Purge Detection

The above method was used with 3M™ Scotch-Weld™ Low Odor Acrylic Adhesive DP810 to determine the optimal time to purge. Traditionally, the nominal open time of 10 minutes would be used for a purge timer after stopping a dispense. In this example, the pause time was 8 minutes and even at this 8 minute stop time, the amount of curing in the static mixer proved to be unrecoverable so that purging did not flush all of the adhesive out of the static mixer.

This method employed a two-step process to determine the time to purge. The first step was to identify a fluid flow stop similar to the above examples using equations 1-6. Next, two buffers were constructed according to equations 7 and 8. These buffers were in turn used to identify a characteristic shift from a rapidly decreasing electrical parameter to a less rapidly decreasing parameter. This was done according to equations 9-11 by using a buffer to calculate the gradient of the last ten data points and then using a second buffer to calculate the gradient of the first buffer. The first signal is found when the second buffer shows a change from negative to positive values. After finding the first characteristic signal, the same buffers are used to find the reverse state where a change from positive to negative is identified. Once the second signal is found, a signal is passed to either the user or a controller to request a purge.

Using this method, a purge was requested at about four and a half minutes. This frequency of purging optimizes the dispensability of the adhesive and reduces the need to change a static mixer due to over-curing in the dispenser.

1. A dispensing system comprising:
a channel through which a material to be dispensed flows;
a sensor within the channel, in direct contact with the material, wherein the sensor is configured to generate a sensor signal indicative of an electrical parameter of the material flow; and
a flow state detector configured to, based on a sensed electrical parameter determined based on the sensor signal, detect a change in flow state of the material within the channel, wherein the change in flow state comprises a start of flow or a stop of flow; and
a communication component configured to communicate the detected change in flow state.

2. The system of claim 1, wherein the detected change in flow state is a detected stop in material flow.

3. The system of claim 1, wherein the detected change in flow state is a detected material flow start.

4. The system of claim 2, and further comprising:
a purge indication generator that, based on the detected stop, is configured to generate a purge indication.

5. The system of claim 4, wherein the purge indication comprises a purge timer selected based on a threshold cure time for the material.

6. The system of claim 2, wherein detecting the change in flow state comprises generating a buffer of a plurality of datapoints, wherein each of the plurality of datapoints comprises a sensor signal value and a timestamp.

7-13. (canceled)

14. The system of claim 1, wherein the detected change in flow state is a first change in flow state, wherein the first change in flow state comprises a detected stop of flow, and wherein a second change in flow state comprises a detected start of flow, and wherein the system further comprises:
a purge clock generator that, based on the detected stop of flow, generates a purge clock and, based on the detected start of flow, cancels the purge clock.

15. The system of claim 4, and wherein the purge indication generator is configured to, generate a purge buffer comprising a plurality of purge datapoints, the plurality of purge datapoints each comprising a sensed electrical parameter and a timestamp.

16. The system of claim 15, wherein the purge indication generator, based on the purge buffer, is configured to detect a purge signal.

17. The system of claim 16, wherein, based on the purge signal, the purge indication generator triggers a purge of the dispensing system, wherein the purge comprises emptying the channel.

18. The system of claim 16, wherein, based on the purge signal, the purge indication generator generates the purge indication.

19. The system of claim 16, wherein the purge signal is a first signal and wherein the purge signal is also generated based on a detected second signal.

20. The system of claim 16, wherein the first signal comprises a rapid change in the sensed electrical parameter, a slow change in the sensed electrical parameter, or a lack of change in the sensed parameter.

21. The system of claim 16, wherein the purge signal comprises a detected stable fit.

22. The system of claim 21, wherein the purge signal generator is further configured to:
fit, for the purge buffer, a first curve from the plurality of purge datapoints;
receive a new sensed signal at a time;
generate a new purge buffer by adding a new datapoint to the purge buffer comprising a new sensed electrical parameter based on the new sensed signal and a new timestamp based on the time;
fit for the new buffer, a second curve;
compare the first and second curve; and
based on the comparison, detect the stable fit.

23. The system of claim 22, wherein comparing comprises determining a variance between the first and second curves and comparing the variance to a threshold variance.

24. The system of claim 4, wherein the generated purge indication comprises a purge timer.

25. The system of claim 4, wherein the generated purge indication is communicated to a user interface generator for a device with a display, and wherein the user interface generator generates a user interface to include the generated purge indication.

26. The system of claim 4, wherein the generated purge indication comprises an indication that a purge is needed.

27-37. (canceled)

38. A method of purging a dispenser, the method comprising:
receiving a sensor signal from a sensor housed within the dispenser, the sensor signal being indicative of an electrical parameter of a material, the material being flowable through the dispenser;
detecting, using a flow state detector, a stop in flow of the material through the dispenser, based on a sensed electrical parameter determined based on the sensor signal;
generating, using a purge indication generator, a purge indication based on the detected stop in flow; and
communicating the generated purge indication, using a communication component.

39-102. (canceled)
